(19) United States
(12) Patent Application Publication
(10) Pub. No.: US 2024/0129826 A1
(43) Pub. Date: Apr. 18, 2024

(54) METHOD AND DEVICE USED IN COMMUNICATION NODE FOR WIRELESS COMMUNICATION

(71) Applicants: Qiaoling YU, Shanghai (CN); Xiaobo ZHANG, Shanghai (CN)

(72) Inventors: Qiaoling YU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/537,847

(22) Filed: Dec. 13, 2023

Related U.S. Application Data
(63) Continuation of application No. PCT/CN2022/097043, filed on Jun. 6, 2022.

(30) Foreign Application Priority Data
Jun. 18, 2021 (CN) 202110675527.4

(51) Int. Cl. H04W 36/30; H04W 36/08; H04W 36/24

(52) U.S. Cl. CPC H04W 36/305; H04W 36/083; H04W 36/249

(57) ABSTRACT

A communication node receives a first message, the first message is used to determine a first criterion and a second criterion; determines that a first cell meets a target criterion, the target criterion is one of the first criterion or the second criterion; transmits a first signal on the first cell; the first criterion comprises at least one of time information or location information, and the first criterion comprises a measurement result for reference signal(s) of the first cell; the second criterion comprises a measurement result for reference signal(s) of the first cell, and the second criterion does not comprise time information and location information; whether the target criterion is the first criterion or the second criterion is related to whether a radio connection problem occurs at the first node. The present application shortens the interruption delay incurred by the radio connection problem in large delay networks.

### CROSS REFERENCE TO RELATED APPLICATIONS

This application is the continuation of the international patent application No. PCT/CN2022/097043, field on Jun. 6, 2022, and claims the priority benefit of Chinese Patent Application No. 202110675527.4, filed on Jun. 18, 2021, the full disclosure of which is incorporated herein by reference.

### BACKGROUND

### Technical Field

The present application relates to transmission methods and devices in wireless communication systems, and in particular to a transmission method and device for large delay.

### Related Art

Facing the increasing demand for communications, 3rd Generation Partner Project (3GPP) started a research on Non-Terrestrial Network (NTN) communications, 3GPP RAN #80 plenary decided to carry out a research project on a solution of New Radio (NR) supporting NTNs, which is a continuation (RP-171450) for a prior research project of NR supporting NTNs. And the mobility of NTN is an important research aspect. 3GPP reduces delay by supporting the use of Conditional Handover (CHO) in NTN, enhances CHO execution conditions in NTN systems, and adds time-based and geographic location-based triggering conditions on the basis of CHO execution conditions in R16.

### SUMMARY

Due to the complexity of the communication environment, it is difficult to ensure CHO reliability in NTN, and how to try to avoid interruption delays when radio connection problems occur requires further research.

To address the above problem, the present application provides a solution. It should be noted that though the present application only took the NTN scenario for example in the statement above; the present application is also applicable to scenarios such as Terrestrial Network (TN) communications, NTN-TN mixed networks, vehicle to everything (V2X) or Layer 2 (L2)/L3 relay, where similar technical effects can be achieved. Additionally, the adoption of a unified solution for various scenarios contributes to the reduction of hardware complexity and costs.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

It should be noted that if no conflict is incurred, embodiments in any node in the present application and the characteristics of the embodiments are also applicable to any other node, and vice versa. And the embodiments in the present application and the characteristics in the embodiments can be arbitrarily combined if there is no conflict.

The present application provides a method in a first node for wireless communications, comprising:
receiving a first message, the first message being used to determine a first criterion and a second criterion;
determining that a first cell meets a target criterion, the target criterion being one of the first criterion or the second criterion; and
transmitting a first signal on the first cell;
herein, the first criterion comprises at least one of time information or location information, and the first criterion comprises a measurement result for reference signal(s) of the first cell; the second criterion comprises a measurement result for reference signal(s) of the first cell, and the second criterion does not comprise time information and location information; the first signal is used to establish a connection with the first cell; whether the target criterion is the first criterion or the second criterion is related to whether radio connection problem occurs at the first node.

In one embodiment, a problem to be solved in the present application comprises: how to avoid interruption delay as much as possible.

In one embodiment, a problem to be solved in the present application comprises: how to restore as soon as possible when radio connection problems occur.

In one embodiment, characteristics of the above method comprise: selecting a target criterion for a same cell based on whether radio connection problems occur.

In one embodiment, characteristics of the above method comprise: configuring at least two cell selection criteria for a single cell.

In one embodiment, characteristics of the above method comprise: configuring at least two cell handover criteria for a single cell.

In one embodiment, characteristics of the above method comprise: an occurrence of a radio connection problem occurred is used to trigger the handover between NTN and TN.

In one embodiment, characteristics of the above method comprise: an occurrence of a radio connection problem is used to determine relaxing a cell selection criterion.

In one embodiment, characteristics of the above method comprise: the radio connection problem comprises Handover Failure (HOF).

In one embodiment, characteristics of the above method comprise: the radio connection problem comprises RLF.

In one embodiment, characteristics of the above method comprise: the radio connection problem comprises that no suitable cell is found.

In one embodiment, characteristics of the above method comprise: the radio connection problem comprises cell selection failure.

In one embodiment, advantages of the above method comprise: avoiding interruption delay.

In one embodiment, advantages of the above method comprise: restoring radio connection problems as soon as possible.

According to one aspect of the present application, comprising:
transmitting a second message, the second message indicating the target criterion.

In one embodiment, characteristics of the above method comprise: a UE notifies the base station whether a first cell is determined based on a first criterion or a second criterion.

In one embodiment, advantages of the above method comprise: being beneficial for Self-Organizing Network (SON)/Minimization of Drive-Test (MDT) optimization and enhancement.

According to one aspect of the present application, comprising:
receiving a first signaling, the first signaling being used to determine a first time length; a relation between a time interval for an occurrence of the radio connection problem at the first node and the first time length is used to determine the target criterion;
herein, the first time length comprises at least one ms.

In one embodiment, characteristics of the above method comprise: selecting a target criterion from a first criterion and a second criterion based on a time interval for an occurrence of the radio connection problem at the UE.

In one embodiment, characteristics of the above method comprise: whether the first cell is determined according to the first criterion or the second criterion is related to a time interval for an occurrence of the radio connection problem at the first node.

In one embodiment, characteristics of the above method comprise: when a time interval for an occurrence of the radio connection problem at the first node is not greater than the first time length, the target criterion is the first criterion; when a time interval for an occurrence of the radio connection problem at the first node is greater than the first time length, the target criterion is the second criterion.

In one embodiment, advantages of the above method comprise: selecting an appropriate criterion based on a length of a time interval for an occurrence of the radio connection problem at the UE to determine a first cell, shortening the interruption delay on the basis of selecting a good cell as much as possible.

In one embodiment, advantages of the above method comprise: the longer a time interval for an occurrence of the radio connection problem at the UE, the looser the target criterion, and the easier it is to select the first cell.

According to one aspect of the present application, comprising:
receiving a second signaling, the second signaling being used to determine a first value; a relation between a number of times that the radio connection problem occurs at the first node and the first value being used to determine the target criterion;
herein, the first value is a non-negative integer.

In one embodiment, characteristics of the above method comprise: selecting a target criterion from a first criterion and a second criterion based on a number of times that the radio connection problem occurs at the UE.

In one embodiment, characteristics of the above method comprise: whether the first cell is determined according to the first criterion or the second criterion is related to a number of times that the radio connection problem occurs at the first node.

In one embodiment, characteristics of the above method comprise: when a number of times that the radio connection problem occurs at the first node is not greater the first value, the target criterion is the first criterion; when a number of times that the radio connection problem occurs at the first node is greater than the first value, the target criterion is the second criterion.

In one embodiment, advantages of the above method comprise: selecting an appropriate criterion based on a number of times that the radio connection problem occurs at the UE to determine a first cell, shortening the interruption delay on the basis of selecting a good cell as much as possible.

In one embodiment, advantages of the above method comprise: the more times the radio connection problem occurs in UE, the looser the target criterion, and the easier it is to select a cell.

According to one aspect of the present application, comprising:
determining that the radio connection problem occurs on a second cell; the behavior of determining that the radio connection problem occurs on a second cell is used to determine that a priority of the first cell is higher than a priority of the second cell;
herein, the priority of the first cell being higher than the priority of the second cell is used to determine that the second criterion does not comprise time information and location information; the first cell is different from the second cell.

In one embodiment, characteristics of the above method comprise: when the first node encounters an occurrence of the radio connection problem on the second cell, the priority of the second cell is lowered.

According to one aspect of the present application, comprising:
receiving a third signaling, the third signaling indicating a first candidate cell group, the first candidate cell group comprising at least one candidate cell, each candidate cell in the first candidate cell group being associated with a candidate condition and a candidate configuration;
herein, the first cell is a candidate cell in the first candidate cell group.

According to one aspect of the present application, comprising:
receiving a first offset;
herein, the target criterion is related to a candidate condition corresponding to the first cell and the first offset.

The present application provides a method in a second node for wireless communications, comprising:
transmitting a first message, the first message being used to determine a first criterion and a second criterion;
receiving a first signal on a first cell;
herein, a first cell meeting a target criterion is determined, the target criterion is one of the first criterion or the second criterion; the first criterion comprises at least one of time information or location information, and the first criterion comprises a measurement result for reference signal(s) of the first cell; the second criterion comprises a measurement result for reference signal(s) of the first cell, and the second criterion does not comprise time information and location information; the first signal is used to establish a connection with the first cell; whether the target criterion is the first criterion or the second criterion is related to whether a radio connection problem occurs in a receiver of the first message.

According to one aspect of the present application, it is characterized in that a second message is transmitted, the second message indicates the target criterion.

According to one aspect of the present application, comprising:
transmitting a first signaling, the first signaling being used to determine a first time length; a relation between a time interval for an occurrence of the radio connection problem at a receiver of the first message and the first time length is used to determine the target criterion;
herein, the first time length comprises at least one ms.

According to one aspect of the present application, comprising:
transmitting a second signaling, the second signaling being used to determine a first value; a relation between a number of times that the radio connection problem occurs in a receiver of the first message and the first value is used to determine the target criterion;
herein, the first value is a non-negative integer.

According to one aspect of the present application, the above method is characterized in that
an occurrence of the radio connection problem on a second cell is determined; an occurrence of the radio connection problem on a second cell is used to determine that a priority of the first cell is higher than a priority of the second cell; the priority of the first cell being higher than the priority of the second cell is used to determine that the second criterion does not comprise time information and location information; the first cell is different from the second cell.

According to one aspect of the present application, comprising:
transmitting a third signaling, the third signaling indicating a first candidate cell group, the first candidate cell group comprising at least one candidate cell, each candidate cell in the first candidate cell group being associated with a candidate condition and a candidate configuration;
herein, the first cell is a candidate cell in the first candidate cell group.

According to one aspect of the present application, comprising:
transmitting a first offset;
herein, the target criterion is related to a candidate condition corresponding to the first cell and the first offset.

The present application provides a first node for wireless communications, comprising:
a first receiver, receiving a first message, the first message being used to determine a first criterion and a second criterion; determining that a first cell meets a target criterion, the target criterion being one of the first criterion or the second criterion; and
a first transmitter, transmitting a first signal on the first cell;
herein, the first criterion comprises at least one of time information or location information, and the first criterion comprises a measurement result for reference signal(s) of the first cell; the second criterion comprises a measurement result for reference signal(s) of the first cell, and the second criterion does not comprise time information and location information; the first signal is used to establish a connection with the first cell; whether the target criterion is the first criterion or the second criterion is related to whether radio connection problem occurs at the first node.

The present application provides a second node for wireless communications, comprising:
a second transmitter, transmitter a first message, the first message being used to determine a first criterion and a second criterion; and
a second receiver, receiving a first signal on a first cell;
herein, a first cell meeting a target criterion is determined, the target criterion is one of the first criterion or the second criterion; the first criterion comprises at least one of time information or location information, and the first criterion comprises a measurement result for reference signal(s) of the first cell; the second criterion comprises a measurement result for reference signal(s) of the first cell, and the second criterion does not comprise time information and location information; the first signal is used to establish a connection with the first cell; whether the target criterion is the first criterion or the second criterion is related to whether a radio connection problem occurs in a receiver of the first message.

In one embodiment, the present application has the following advantages over conventional schemes:
avoiding the interruption delay;
restoring radio connection problems as soon as possible;
improving the success probability of cell selection;
being conducive to selecting a more suitable cell.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of transmission of a first message and a first signal according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of radio signal transmission according to one embodiment of the present application;

FIG. 6 illustrates a flowchart of radio signal transmission according to another embodiment of the present application;

FIG. 7 illustrates a flowchart of a relation between a time interval for an occurrence of a radio connection problem at a first node and a first time length being used to determine a target criterion according to one embodiment of the present application;

FIG. 8 illustrates a flowchart of a relation between a number of times that a radio connection problem occurs at a first node and a first value being used to determine a target criterion according to one embodiment of the present application;

FIG. 9 illustrates a flowchart of a relation between a number of times that a radio connection problem occurs at a first node and a first value being used to determine a target criterion according to one embodiment of the present application;

FIG. 10 illustrates a schematic diagram of a relation between a number of times that radio connection problem occurs at a first node and a first value according to one embodiment of the present application;

FIG. 11 illustrates a schematic diagram of a relation between a time interval that a radio connection problem occurs in a first node and a first time length according to one embodiment of the present application;

FIG. 12 illustrates a structure block diagram of a processor in a first node according to one embodiment of the present application;

FIG. 13 illustrates a structure block diagram of a processor in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

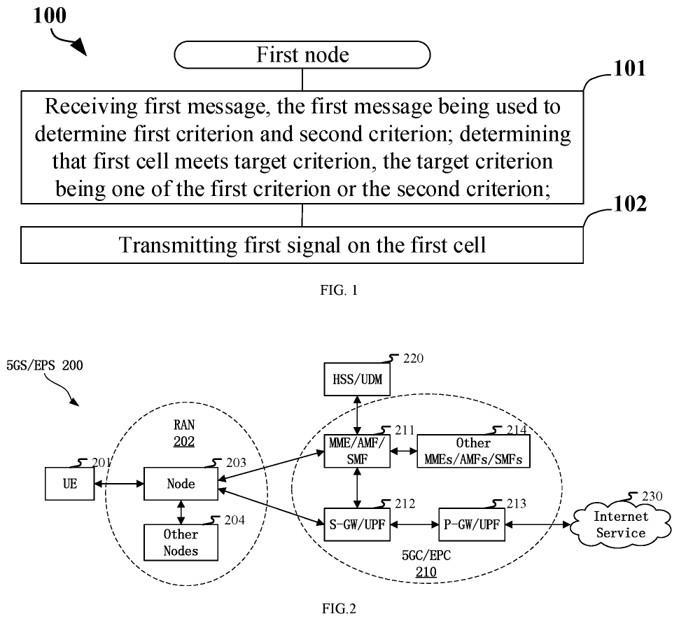

Embodiment 1 illustrates a flowchart of transmission of a first message and a first signal according to one embodiment of the present application, as shown in FIG. 1. In FIG. 1, each block represents a step, and it should be particularly noted that the sequence order of each box herein does not imply a chronological order of steps marked respectively by these boxes.

In Embodiment 1, a first node in the present application receives a first message in step 101, and the first message is used to determine a first criterion and a second criterion; determines that a first cell meets a target criterion, the target criterion is one of the first criterion or the second criterion; in step 102, transmits a first signal on the first cell; herein, the first criterion comprises at least one of time information or location information, and the first criterion comprises a measurement result for reference signal(s) of the first cell; the second criterion comprises a measurement result for reference signal(s) of the first cell, and the second criterion does not comprise time information and location information; the first signal is used to establish a connection with the first cell; whether the target criterion is the first criterion or the second criterion is related to whether a radio connection problem occurs at the first node.

In one embodiment, a cell is an NTN cell, which refers to that a maintenance base station of the cell is deployed in the air.

In one embodiment, a cell is an NTN cell, which refers to that a maintenance base station of the cell is deployed in Geostationary Earth Orbit (GEO), or Airborne vehicles, or Unmanned Aircraft Systems (UAS), or Lighter than Air (LTA) UAS, or Healer than Air (HTA) UAS, or Spaceborne vehicles, or Low Earth Orbiting (LEO), or Medium Earth Orbiting (MEO), or High Elliptic Orbiting (HEO), or High Altitude Platform Station (HAPS), or NTN gateway (NTN gateway), or Satellite.

In one embodiment, an NTN cell comprises a beam.

In one embodiment, an NTN cell comprises a Physical Cell Identity (PCI).

In one embodiment, an NTN cell comprises multiple PCIs.

In one embodiment, an NTN cell comprises at least one footprint.

In one embodiment, an NTN cell comprises multiple beams.

In one embodiment, an NTN cell comprises a Cell Global Identity (CGI).

In one embodiment, the first message is transmitted via a radio interface.

In one embodiment, the first message is a higher-layer message.

In one embodiment, a Signalling Radio Bearer (SRB) of the first message comprises SRB1.

In one embodiment, a Signaling Radio Bearer of the first message comprises SRB3.

In one embodiment, the first message comprises at least one Radio Resource Control (RRC) message.

In one embodiment, the first message comprises at least one Information Element (IE).

In one embodiment, the first message comprises at least one field.

In one embodiment, one RRC message in the first message comprises System Information Block 2 (SIB2).

In one embodiment, the first message comprises at least one of SIB1, SIB2, SIB3, SIB4, or SIB5.

In one embodiment, the first message comprises SIBxx, and the xx is equal to one of 15 to 30.

In one embodiment, the first message comprises an RRCReconfiguration message or an RRCConnectionReconfiguration message.

In one embodiment, the first message comprises an IE, and a name of the IE comprises CellGroupConfig.

In one embodiment, the first message comprises an IE, and a name of the IE comprises CondReconfigToAddModList or CondReconfigurionToAddModList.

In one embodiment, the first message comprises an IE, and a name of the IE comprises CondReconfigId or condReconfigurationId.

In one embodiment, the first message comprises a field, and a name of the field comprises condExecutionCond or triggerCondition.

In one embodiment, the first message comprises a field, and a name of the field comprises condRRCReconfig or condReconfigurationToApply.

In one embodiment, the first message comprises a field, and a name of the field comprises ReconfigurationWithSync or mobilityControlInfo.

In one embodiment, the first message comprises a field, and a name of the field comprises t304.

In one embodiment, the first message comprises an IE, and a name of the IE comprises ConditionalReconfiguration.

In one embodiment, the first message comprises a field, and a name of the field comprises attemptCondReconfig or attemptCondReconf, and a value of the field is set as true.

In one embodiment, the phrase of the first message being used to a first criterion and a second criterion comprises: the first message is used to configure the first criterion and the second criterion.

In one embodiment, the phrase of the first message being used to a first criterion and a second criterion comprises: the first message indicates the first criterion and the second criterion.

In one embodiment, the phrase of the first message being used to a first criterion and a second criterion comprises: an RRC message in the first message is used to determine the first criterion, and another RRC message in the first message is used to determine the second criterion.

In one subembodiment of the embodiment, the RRC message and the another RRC message belong to different RRC messages.

In one subembodiment of the embodiment, the RRC message and the another RRC message belong to a same RRC message.

In one subembodiment of the embodiment, the RRC message and the another RRC message are received at the same time.

In one subembodiment of the embodiment, the RRC message and the another RRC message are received not at the same time.

In one embodiment, the conditional reconfiguration is for a Primary Cell (PCell).

In one embodiment, the conditional reconfiguration is for a PCell of a Master Cell Group (MCG).

In one embodiment, the conditional reconfiguration comprises Conditional Handover (CHO).

In one embodiment, the conditional reconfiguration is CHO.

In one embodiment, the first criterion is valid for NTN cells.

In one embodiment, the first criterion is only for NTN cells.

In one embodiment, the second criterion comprises a Cell Selection Criterion.

In one embodiment, the second criterion comprises conditional reconfiguration execution conditions.

In one embodiment, the second criterion is valid for TN cells.

In one embodiment, the second criterion is valid for NTN cells.

In one embodiment, the second criterion is valid for both TN cells and NTN cells.

In one embodiment, the conditional reconfiguration execution condition comprises: execution conditions that need to be met in order to trigger an execution of conditional reconfiguration (the first criterion is the execution condition that needs to be fulfilled in order to trigger the execution of a conditional reconfiguration).

In one embodiment, for an NTN cell, the first node follows the first criterion.

In one embodiment, for an NTN cell, the first node follows the first criterion or the second criterion.

In one embodiment, for a TN cell, the first node does not follow the first criterion.

In one embodiment, for an NTN cell, the first node is configured with the first criterion and the second criterion at the same time.

In one subembodiment of the embodiment, for the NTN cell, the first node does not follow both the first criterion and the second criterion at the same time.

In one subembodiment of the embodiment, for the NTN cell, the first node follows both the first criterion and the second criterion at the same time.

In one embodiment, an NTN cell is configured with one of the first criterion or the second criterion.

In one embodiment, the behavior of determining a first cell based on a target criterion comprises judging that the first cell meets the target criterion.

In one subembodiment of the above embodiment, the target criterion is the second criterion, and the first node is a cell with highest Reference Signal Received Power (RSRP).

In one subembodiment of the above embodiment, the target criterion is the second criterion, and the first cell is a cell with second highest RSRP.

In one subembodiment of the above embodiment, the target criterion is the first criterion, and the first cell is any cell in all detected cells.

In one subembodiment of the above embodiment, the target criterion is the first criterion, and the first cell is any cell outside the blacklist in all detected cells.

In one embodiment, the first cell is a non-serving cell that meets the target criterion.

In one embodiment, the first cell is a cell that meets the target criterion.

In one embodiment, the behavior of determining that a first cell meets a target criterion comprises: selecting the first cell according to the target criterion.

In one embodiment, the behavior of determining that a first cell meets a target criterion comprises: when the first cell meets the target criterion, selecting the first cell.

In one embodiment, the behavior of determining that a first cell meets a target criterion comprises: evaluating the target criterion according to section 5.3.5.13.4 of reference 3GPP TS 38.331; herein, the target criterion is a CHO execution condition associated with the first cell.

In one embodiment, the behavior of determining that a first cell meets a target criterion comprises: according to triggering amount comprised in the target criterion, determining that the first cell meets the target criterion.

In one embodiment, the behavior of determining that a first cell meets a target criterion comprises: determining that the first cell meets the first criterion; herein, the radio connection problem occurs at the first node, and the target criterion is the first criterion.

In one embodiment, the behavior of determining that a first cell meets a target criterion comprises: determining that the first cell meets the second criterion; herein, the radio connection problem does not occur in the first node, and the target criterion is the second criterion.

In one embodiment, the behavior of determining that a first cell meets a target criterion comprises: determining that the first cell meets the first criterion; herein, the radio connection problem does not occur in the first node, and the target criterion is the first criterion.

In one embodiment, the behavior of determining that a first cell meets a target criterion comprises: determining that the first cell meets the second criterion; herein, the radio connection problem occurs at the first node, and the target criterion is the second criterion.

In one embodiment, the behavior of determining that a first cell meets a target criterion comprises: evaluating the first cell based on the target criterion to determine that the first cell meets the target criterion.

In one embodiment, the behavior of determining that a first cell meets a target criterion comprises: determining that the first cell meets the Q1 first-type inequality constraint(s) and the Q2 second-type inequality constraint(s); herein, the target criterion is the first criterion.

In one embodiment, the behavior of determining that a first cell meets a target criterion comprises: determining that the first cell satisfies the Q1 first-type inequality constraint(s); herein, the target criterion is the second criterion.

In one embodiment, the phrase that the target criterion is one of the first criterion or the second criterion comprises: the target criterion is determined in the first criterion and the second criterion.

In one embodiment, the phrase that the target criterion is one of the first criterion or the second criterion comprises: the target criterion is the first criterion or the second criterion.

In one embodiment, the phrase that the target criterion is one of the first criterion or the second criterion comprises: the target criterion is not a criterion other than of the first criterion and the second criterion.

In one embodiment, the first cell comprises a Target Cell.

In one embodiment, the first cell comprises a CHO candidate cell.

In one embodiment, the first cell is a cell meeting the target criterion.

In one embodiment, the first cell is any cell in multiple cells meeting the target criterion.

In one embodiment, the first cell is a best cell among multiple cells that meet the target criterion.

In one embodiment, the first cell is a highest ranked cell in terms of RSRP, Reference Signal Received Quality (RSRQ), or Signal to Interference plus Noise Ratio (SINR) among multiple cells meeting the target criterion.

In one embodiment, the first cell is an acceptable cell, and the acceptable cell is defined as in reference 3GPP TS 38.304.

In one embodiment, the first cell is a suitable cell, and the suitable cell is defined as in reference 3GPP TS 38.304.

In one embodiment, the first signal is transmitted via a radio interface.

In one embodiment, the first signal is a physical-layer signal.

In one embodiment, the first signal is an RRC message.

In one embodiment, the first signal comprises a Medium Access Control (MAC) Protocol Data Unit (PDU).

In one embodiment, the first signal comprises a MAC Control Element (CE).

In one embodiment, the first signal comprises a PUSCH.

In one embodiment, the first signal comprises a PRACH.

In one embodiment, a signaling radio bearer of the first signal comprises an SRB0.

In one embodiment, a signaling radio bearer of the first signal comprises an SRB1.

In one embodiment, the phrase of transmitting a first signal on the first cell comprises: the first signal being associated with the first cell.

In one embodiment, the phrase of transmitting a first signal on the first cell comprises: the first signal being transmitted on the first cell.

In one embodiment, the phrase of transmitting a first signal on the first cell comprises: the first signal being transmitted by using resources of the first cell.

In one embodiment, the phrase of transmitting a first signal on the first cell comprises: time-frequency resources of the first signal being allocated by the first cell.

In one embodiment, the phrase of transmitting a first signal on the first cell comprises: an identifier of the first signal being allocated by the first cell.

In one embodiment, the phrase of the first signaling being used to establishing a connection with the first cell comprises: the first signal is used for random access process.

In one subembodiment of the embodiment, the first signal comprises at least Random Access Preamble.

In one subsidiary embodiment of the above subembodiment, the random access preamble comprises a bit string.

In one subsidiary embodiment of the above subembodiment, the random access preamble comprises a sequence.

In one subsidiary embodiment of the subembodiment, the random access preamble is transmitted on a Physical Random Access Channel (PRACH).

In one subsidiary embodiment of the subembodiment, the random access preamble comprises a Random Access Channel (RACH) signal.

In one subsidiary embodiment of the above subembodiment, the random access preamble comprises a physical-layer signal.

In one subembodiment of the embodiment, the first signal comprises Message 1 (Msg1) of a 4-step random access (4-stepRA) process.

In one subembodiment of the embodiment, the first signal comprises Message A (MsgA) of a 2-step random access (2-stepRA) process.

In one subembodiment of the above embodiment, the first signal only comprises a random access preamble.

In one subembodiment of the above embodiment, the first signal comprises a random access preamble and a given load, and the given payload is transmitted on a Physical Uplink Shared Channel (PUSCH).

In one embodiment, the phrase of the first signaling being used to establishing a connection with the first cell comprises: the first signal is used to confirm the successful completion of an RRC connection reconfiguration, and the RRC connection reconfiguration comprises ReconfigurementWithSync.

In one subembodiment of the embodiment, the first signal is used to determine that RRC connection reconfiguration for the first cell in the first message is successfully completed.

In one subembodiment of the above embodiment, the first signal is used to determine a successful application of a configuration of the first cell.

In one subembodiment of the above embodiment, the first signal comprises an RRCReconfigurationComplete message.

In one subembodiment of the above embodiment, the first signal comprises an IE, and a name of the IE comprises UE-MeasurementsAvailable.

In one subembodiment of the above embodiment, the first signal comprises a field, a name of the field comprises rlf-InfoAvailable, and a value of the field is set to true.

In one subembodiment of the above embodiment, the first signal comprises a field, a name of the field comprises at least one of succ, ho, or InfoAvailable, and a value of the field is set as true.

In one embodiment, the phrase of the first signaling being used to establishing a connection with the first cell comprises: the first signal is used to request the reestablishment of an RRC connection.

In one subembodiment of the above embodiment, the first signal comprises an RRCReestablishmentRequest message or an RRCConnectionReestablishmentRequest message.

In one subembodiment of the embodiment, the first signal comprises ue-Identity.

In one subembodiment of the embodiment, the first signal comprises ReestablishmentCause.

In one subembodiment of the embodiment, the first signal comprises newUE-Identity.

In one subembodiment of the embodiment, the first signal indicates a Cell Radio Network Temporary Identifier (C-RNTI).

In one embodiment, as a response to the behavior of determining that a first cell meets a target criterion, a first signal is transmitted on the first cell.

In one embodiment, as a response to the behavior of determining that a first cell meets a target criterion, a candidate configuration corresponding to the first cell is applied; as a response to a completion of applying a candidate configuration corresponding to the first cell, the first signal is transmitted on the first cell.

In one subembodiment of the embodiment, a candidate configuration corresponding to the first cell comprises a configuration in a ReconfigurationWithSync field or mobilityControlInfo field.

In one subsidiary embodiment of the above subembodiment, a candidate configuration corresponding to the first cell is configured by the third signaling

In one subsidiary embodiment of the above subembodiment, a candidate configuration corresponding to the first cell is configured by a field in an RRC message, and a name of the field comprises condRRCReconfig.

In one subsidiary embodiment of the above subembodiment, the first signal comprises an RRCReconfigurationComplete message or an RRCConnectionReconfigurationComplete message.

In one subsidiary embodiment of the subembodiment, the first signal comprises preamble.

In one subembodiment of the embodiment, a candidate configuration corresponding to the first cell comprises a default configuration, the default configuration comprises at least one of a default L1 parameter value, a default MAC cell group configuration in section 9.2.2 of reference 3GPP TS38.331, a default CCCH configuration in section 9.1.1.2 of reference 3GPP TS38.331, or timeAlignmentTimerCommon in SIB1.

In one subsidiary embodiment of the subembodiment, the first signal comprises an RRCReestablishmentRequest message or an RRCConnectionReestablishmentRequest message.

In one subsidiary embodiment of the subembodiment, the first signal comprises preamble.

In one embodiment, time information comprises at least one moment.

In one embodiment, time information comprises at least one timer.

In one embodiment, the time information comprises a System Frame Number (SFN).

In one embodiment, the time information comprises Universal Time Coordinated (UTC).

In one embodiment, the time information is related to the satellite ephemeris.

In one embodiment, the time information is related to satellite ephemeris and a location of the first node.

In one embodiment, the location information comprises a location of the first node.

In one embodiment, the location information comprises a geographical location.

In one embodiment, the location information comprises a relative location.

In one embodiment, the location information comprises an absolute location.

In one embodiment, the location information comprises a distance between the first node and a reference point.

In one subembodiment of the above embodiment, the reference point comprises a cell center.

In one subembodiment of the above embodiment, the reference point is a predefined location.

In one subembodiment of the above embodiment, the reference point comprises a reference point of a serving cell.

In one subembodiment of the above embodiment, the reference point comprises a reference point of a target cell.

In one subembodiment of the above embodiment, the reference point comprises a reference point of a candidate cell.

In one subembodiment of the above embodiment, the reference point is configured through network.

In one subembodiment of the above embodiment, the reference point is obtained through ephemeris information.

In one embodiment, the location information comprises at least one of longitude, dimension, or elevation of the first node.

In one embodiment, the location information comprises an area identifier of an area where the first node is located.

In one embodiment, the reference signal (RS) of the first cell comprises at least one of a Channel State Information Reference Signal (CSI-RS), a Synchronization Signal Block (SSB), or a Synchronization Signal (SS)/Physical Broadcast Channel (PBCH) block.

In one embodiment, the measurement result of the reference signal of the first cell comprise at least one of RSRP, RSRQ, SINR, Received Signal Code Power (RSCP), or EcNO.

In one embodiment, the measurement result of the reference signal of the first cell is RSRP.

In one embodiment, the measurement result of the reference signal in the first cell comprises a cell measurement result of L3 filtering.

In one embodiment, the first criterion also comprises a measurement result for reference signal(s) of a serving cell.

In one embodiment, the second criterion also comprises a measurement result for reference signal(s) of a serving cell.

In one embodiment, the serving cell comprises a PCell.

In one embodiment, the serving cell comprises a source cell.

In one embodiment, the serving cell comprises a PSCell.

In one embodiment, the first criterion and the second criterion are configured through a same RRC message.

In one embodiment, the first criterion and the second criterion are configured through different RRC messages.

In one embodiment, the first criterion comprises a cell selection criterion (S criterion), and the second criterion comprises another cell selection criterion.

In one subembodiment of the above embodiment, the cell selection criterion refers to section 5.2.3.2 of reference 3GPP TS 38.304.

In one embodiment, the first criterion comprises a cell reselection criterion (R criterion), and the second criterion comprises another cell reselection criterion.

In one embodiment, the first criterion comprises a CHO execution condition, and the second criterion comprises another CHO execution condition.

In one embodiment, the first criterion comprises a CHO execution condition, and the second criterion comprises a cell selection criterion.

In one embodiment, the first criterion comprises a CHO execution condition, and the second criterion comprises a cell reselection criterion.

In one embodiment, the CHO execution condition comprises an entry condition.

In one embodiment, the first criterion is only used for an NTN cell, and the second criterion is used for an NTN cell and a TN cell.

In one embodiment, the first criterion is only used for an NTN cell, and the second criterion is used for an NTN cell.

In one embodiment, the first criterion is only used for an NTN cell, and the second criterion is used for a TN cell.

In one embodiment, the first criterion comprises an entry condition for event A3.

In one embodiment, the first criterion comprises an entry condition for event A4.

In one embodiment, the first criterion comprises an entry condition for event A5.

In one embodiment, the second criterion comprises an entry condition for event A3.

In one embodiment, the second criterion comprises an entry condition for event A4.

In one embodiment, the second criterion comprises an entry condition for event A5.

In one embodiment, the first criterion comprises Q1 first-type inequality constraint(s), and the first criterion comprises Q2 second-type inequality constraint(s); Q1 is a positive integer, Q2 is a positive integer, Q1 is not greater than 8, and Q2 is not greater than 8.

In one subembodiment of the above embodiment, Q1 is equal to 1 or the Q1 is equal to 2.

In one subembodiment of the above embodiment, Q2 is equal to 1 or the Q2 is equal to 2.

In one embodiment, the first criterion comprises Q1 first-type inequality constraint(s), and the first criterion is related to a given timer; Q1 is a positive integer and is not greater than 8.

In one embodiment, the first criterion comprises Q1 first-type inequality constraint(s), the first criterion comprises Q2 second-type inequality constraint(s), and the first criterion is related to a given timer; Q1 is a positive integer, Q2 is a positive integer, Q1 is not greater than 8, and Q2 is not greater than 8.

In one embodiment, the second criterion comprises Q3 first-type inequality constraint(s), and the second criterion does not comprise second-type inequality constraint(s); Q1 is a positive integer and is not greater than 8.

In one subembodiment of the above embodiment, Q3 is equal to 1 or the Q3 is equal to 2.

In one embodiment, the behavior of determining that a first cell meets a target criterion comprises: confirming that both the Q1 first-type inequality constraint(s) and the Q2 first-type inequality constraint(s) are satisfied; herein, the target criterion is the first criterion.

In one embodiment, the behavior of determining that a first cell meets a target criterion comprises: confirming that the Q3 first-type inequality constraint(s) is(are) satisfied; herein, the target criterion is the second criterion.

In one embodiment, the first-type inequality comprises a measurement result for reference signal(s) of the first cell.

In one embodiment, the first-type inequality comprises a measurement result for reference signal(s) of a PCell of the first node.

In one embodiment, the Q1 first-type inequality constraint(s) comprises(comprise) an inequality constraint A3-1 (entry condition) in section 5.5.4.4 of reference 3GPP TS 38.331; herein, Q1 is equal to 1.

In one embodiment, the Q1 first-type inequality constraint(s) comprises(comprise) an inequality constraint A4-1 (entry condition) in section 5.5.4.5 of reference 3GPP TS 38.331; herein, Q1 is equal to 1.

In one embodiment, the Q1 first-type inequality constraint(s) comprises(comprise) an inequality constraint A5-1 (entry condition) in section 5.5.4.6 of reference 3GPP TS 38.331 and an inequality constraint A5-2 (entry condition); herein, Q2 is equal to 2.

In one embodiment, the Q3 first-type inequality constraint(s) comprises(comprise) an inequality constraint A3-1 (entry condition) in section 5.5.4.4 of reference 3GPP TS 38.331; herein, Q3 is equal to 1.

In one embodiment, the Q3 first-type inequality constraint(s) comprises(comprise) an inequality constraint A4-1 (entry condition) in section 5.5.4.5 of reference 3GPP TS 38.331; herein, Q3 is equal to 1.

In one embodiment, the Q3 first-type inequality constraint(s) comprises(comprise) an inequality constraint A5-1 (entry condition) in section 5.5.4.6 of reference 3GPP TS 38.331 and an inequality constraint A5-2 (entry condition); herein, Q3 is equal to 2.

In one embodiment, at least one inequality constraint among the Q1 first-type inequality constraint(s) in the first criterion is the same as at least one inequality constraint among the Q3 first-type inequality constraint(s) in the second criterion.

In one embodiment, any inequality constraint among the Q1 first-type inequality constraint(s) in the first criterion is different from any inequality constraint among the Q3 first-type inequality constraint(s) in the second criterion.

In one embodiment, the second-type inequality constraint comprises time information.

In one embodiment, the second-type inequality constraint comprises location information.

In one embodiment, the second-type inequality constraint is related to timing information.

In one embodiment, the second-type inequality constraint is related to location information.

In one embodiment, the Q2 second-type inequality constraint(s) comprise(s): a first distance<a target distance threshold; herein, Q2 is equal to 1.

In one embodiment, the Q2 second-type inequality constraint(s) comprise(s): a first distance<a target distance threshold, and a second distance>a given distance threshold; herein, Q2 is equal to 2.

In one embodiment, the Q2 second-type inequality constraint(s) comprise(s): a first distance<a second distance; herein, Q2 is equal to 1.

In one embodiment, the first distance comprises a distance from the first node to a center of the first cell.

In one embodiment, a unit for measurement of the first distance is the same as a unit for measurement of the target distance threshold.

In one embodiment, the first distance is determined based on satellite ephemeris and a geographical location of the first node.

In one embodiment, the first distance is determined by UE implementation.

In one embodiment, the first distance comprises at least one offset.

In one embodiment, the second distance comprises a distance from the first node to a cell center of a PCell.

In one embodiment, a unit for measurement of the second distance is the same as a unit for measurement of the given distance threshold.

In one embodiment, the second distance is determined based on satellite ephemeris and a geographical location of the first node.

In one embodiment, the second distance is determined by UE implementation.

In one embodiment, the second distance comprises at least one offset.

In one embodiment, the target distance threshold is configurable.

In one embodiment, the target distance threshold comprises at least one offset.

In one embodiment, the target distance threshold is a threshold.

In one embodiment, the given distance threshold is configurable.

In one embodiment, the given distance threshold comprises at least one offset.

In one embodiment, the given distance threshold is a threshold.

In one embodiment, the Q2 second-type inequality constraint(s) comprise(s): a first ratio<a target ratio threshold; herein, Q2 is equal to 1.

In one embodiment, the Q2 second-type inequality constraint(s) comprise(s): a first ratio<a target ratio threshold, and a second distance>a given ratio threshold; herein, Q2 is equal to 2.

In one embodiment, the Q2 second-type inequality constraint(s) comprise(s): a first ratio<a second ratio; herein, Q2 is equal to 1.

In one embodiment, the first ratio is equal to [a quotient of (a distance between the first node and a center of the first cell) and a coverage radius of the first cell].

In one embodiment, the second ratio is equal to [a quotient of (a distance between the first node and a center of the PCell) and a coverage radius of the PCell].

In one embodiment, the target ratio threshold is configurable.

In one embodiment, the target ratio threshold comprises at least one offset.

In one embodiment, the target ratio threshold is a threshold.

In one embodiment, the target ratio threshold is a decimal between 0 and 1.

In one embodiment, the given ratio threshold is configurable.

In one embodiment, the given ratio threshold comprises at least one offset.

In one embodiment, the given ratio threshold is a threshold.

In one embodiment, the given ratio threshold is a decimal between 0 and 1.

In one embodiment, the Q2 second-type inequality constraint(s) comprise(s): a first time value<a target time length; herein, Q2 is equal to 1.

In one embodiment, the Q2 second-type inequality constraint(s) comprise(s): a first time value<a target time length, and a second time value<a given time length; herein, Q2 is equal to 2.

In one embodiment, the first time value comprises a time length before the first node can be served by a maintenance base station of the first cell.

In one embodiment, the second time value comprises a time length the first node can still be served by a maintenance base station of the PCell.

In one embodiment, the target time length is configurable.

In one embodiment, the target time length comprises at least one offset.

In one embodiment, the target time length is a threshold.

In one embodiment, the target time length is measured by ms.

In one embodiment, the target time length is a non-negative integer.

In one embodiment, the target time length is configurable.

In one embodiment, the target time length comprises at least one offset.

In one embodiment, the target time length is a threshold.

In one embodiment, the target time length is measured by ms.

In one embodiment, the target time length is a non-negative integer.

In one embodiment, the phrase of the first criterion comprising time information comprises: the first criterion being related to a given timer.

In one subembodiment of the embodiment, when a pre-configured time is reached, start the given timer.

In one subembodiment of the embodiment, when a message is received, start the given timer.

In one subembodiment of the embodiment, when another pre-configured time is received, stop the given timer.

In one subembodiment of the embodiment, when an application of the candidate configuration is started, stop the given timer.

In one subembodiment of the embodiment, the behavior of starting the given timer is related to at least one of time, satellite ephemeris, or a location of the first node.

In one subembodiment of the embodiment, the behavior of stopping the given timer is related to at least one of time, satellite ephemeris, or a location of the first node.

In one subembodiment of the embodiment, the given timer being running is used to determine that the first cell cannot provide services to the first node.

In one subsidiary embodiment of the subembodiment, when the given timer expires, a condition of the first criterion related to time information is satisfied.

In one subsidiary embodiment of the subembodiment, when the given timer expires, start evaluating the Q1 first-type inequality constraint(s).

In one subsidiary embodiment of the subembodiment, when the given timer expires, start evaluating the Q1 first-type inequality constraint(s) and the Q2 second-type inequality constraint(s).

In one subsidiary embodiment of the subembodiment, the first criterion comprises that the given timer is not running.

In one subsidiary embodiment of the subembodiment, the behavior of determining that a first cell meets a first criterion comprises: determining that the given timer is not running.

In one subembodiment of the embodiment, the given timer being running is used to determine that the first cell capable of providing services to the first node.

In one subsidiary embodiment of the subembodiment, the first criterion comprises that the given timer is running.

In one subsidiary embodiment of the subembodiment, the behavior of determining that a first cell meets a first criterion comprises: determining that the given timer is running.

In one subsidiary embodiment of the subembodiment, when the given timer is started, a condition of the first criterion related to time information is satisfied.

In one subsidiary embodiment of the subembodiment, when the given timer is started, start evaluating the Q1 first-type inequality constraint(s).

In one subsidiary embodiment of the subembodiment, when the given timer is started, start evaluating the Q1 first-type inequality constraint(s) and the Q2 second-type inequality constraint(s).

In one embodiment, the phrase of the first criterion comprising at least one of time information or location information, and the first criterion comprising a measurement result for a reference signal of the first cell comprises: trigger quality of the first criterion comprises at least one of time information or location information, as well as a measurement result for a reference signal of the first cell.

In one embodiment, the phrase of the first criterion comprising at least one of time information or location information, and the first criterion comprising a measurement result for a reference signal of the first cell comprises: measurement quality of the first criterion comprises at least one of time information or location information, as well as a measurement result for a reference signal of the first cell.

In one embodiment, the phrase of the first criterion comprising at least one of time information or location information, and the first criterion comprising a measurement result for a reference signal of the first cell comprises: the first criterion is related to at least one of time information or location information, as well as a measurement result for a reference signal of the first cell.

In one embodiment, the first criterion comprises time information and a measurement result for a reference signal of the first cell.

In one embodiment, the first criterion comprises location information and a measurement result for a reference signal of the first cell.

In one embodiment, the first criterion comprises time information, location information and a measurement result for a reference signal of the first cell.

In one embodiment, the first criterion is related to time information and a measurement result for a reference signal of the first cell.

In one embodiment, the first criterion is related to location information and a measurement result for a reference signal of the first cell.

In one embodiment, the first criterion is related to time information, location information and a measurement result for a reference signal of the first cell.

In one embodiment, the phrase of the second criterion comprising a measurement result for a reference signal of the first cell, and the second criterion not comprising time information and location information comprises: the second criterion is related to a measurement result for a reference signal of the first cell, and is unrelated to time information and location information.

In one embodiment, the phrase of whether the target criterion is the first criterion or the second criterion being related to whether radio connection problem occurs in the first node comprises: whether the radio connection problem occurs in the first node is used to determine whether the target criterion is the first criterion or the second criterion.

In one embodiment, the sentence of whether the target criterion is the first criterion or the second criterion being related to whether radio connection problem occurs at the first node comprises: when the radio connection problem occurs at the first node, the target criterion is the second criterion; when the radio connection problem does not occur in the first node, the target criterion is the first criterion.

In one embodiment, the sentence of whether the target criterion is the first criterion or the second criterion being related to whether radio connection problem occurs at the first node comprises: when the radio connection problem occurs at the first node, the target criterion is the first criterion; when the radio connection problem does not occur in the first node, the target criterion is the second criterion.

In one embodiment, the radio connection problem comprises Reconfiguration with sync Failure.

In one embodiment, the radio connection problem comprises RLF.

In one subembodiment of the embodiment, upon T310 expiry in PCell, it is determined that the radio connection problem occurs.

In one subembodiment of the embodiment, upon T312 expiry in PCell, it is determined that the radio connection problem occurs.

In one subembodiment of the embodiment, upon random access problem indication from MCG MAC while neither T300, T301, T304, T311 nor T319 are running, it is determined that the radio connection problem occurs.

In one subembodiment of the embodiment, upon indication from MCG RLC that the maximum number of retransmissions has been reached, it is determined that the radio connection problem occurs.

In one subembodiment of the embodiment, if connected as an Integrated Access and Backhaul-node (IAB-node), upon Backhaul (BH) RLF indication received on Backhaul Adaptation Protocol (BAP) entity from the MCG, it is determined that the radio connection problem occurs.

In one subembodiment of the above embodiment, upon consistent uplink LBT failure indication from MCG MAC while T304 is not running, it is determined that the radio connection problem occurs.

In one subembodiment of the above embodiment, the behavior of determining an occurrence of the radio connection problem comprises: it is considered that an MCG has been detected as RLF, i.e. MCG RLF.

In one embodiment, the radio connection problem comprises Handover Failure (HOF).

In one subembodiment, when the timer T304 of an MCG is expired, it is determined that the radio connection problem occurs.

In one subembodiment of the above embodiment, when T304 of an SCG expires, it is determined that the radio connection problem occurs.

In one subembodiment of the above embodiment, when T307 of an SCG expires, it is determined that the radio connection problem occurs.

In one embodiment, the radio connection problem comprises Conditional Handover Failure (CHOF).

In one subembodiment of the above embodiment, the radio connection problem comprises Reconfiguration with sync Failure.

In one embodiment, the radio connection problem comprises that no suitable cell is found.

In one embodiment, the radio connection problem comprises cell selection failure.

In one embodiment, a measurement result for the reference signal of the first cell lower than a threshold is used to determine an occurrence of the radio connection problem; the threshold is configurable.

In one embodiment, a sum of a value of a first timer and a target offset not being less than an expiration value of the first timer is used to determine an occurrence of the radio connection problem; herein, the target offset is an offset for the first timer, the target offset comprises at least 1 millisecond, and the target offset is not greater than the expiration value of the first timer.

In one subembodiment of the embodiment, the first timer comprises T310.

In one subembodiment of the embodiment, the first timer comprises T304.

In one subembodiment of the embodiment, the first timer comprises T312.

In one subembodiment of the embodiment, the first timer comprises T311.

In one embodiment, upon receiving an indication from a lower layer, the indication is used to determine that RLF is about to occur.

In one subembodiment of the embodiment, the lower layer comprises a MAC layer.

In one subembodiment of the above embodiment, the lower layer comprises an RLC layer.

In one subembodiment of the embodiment, the lower layer comprises a PHY layer.

In one subembodiment of the above embodiment, the phrase of RLF about to occur comprises: a sum of a first counter and a given offset reaches a maximum value of the first counter; herein, the given offset is an offset for the first counter, the given offset is a non-negative integer, and the given offset is not greater than a maximum value of the first counter.

In one subembodiment of the embodiment, the first counter comprises RETX_COUNT, the first counter is used to determine a number of RLC retransmissions, and the maximum value of the first counter comprises maxRetxThreshold.

In one subembodiment of the embodiment, the first counter comprises BFISOUNTER, the first counter is used to determine a number of times beam failure instance indications are received from the physical layer, and the maximum value of the first counter comprises beamFailurelnstanceMaxCount.

In one subembodiment of the embodiment, the first counter comprises LBT_COUNTER, the first counter is used to determine a number of times LBT failure indications are received from the physical layer, and the maximum value of the first counter comprises lbt-FailurelnstanceMaxCount.

### Embodiment 2

Embodiment 2 illustrates a schematic diagram of a network architecture according to one embodiment of the present application, as shown in FIG. 2. FIG. 2 is a diagram illustrating a network architecture 200 of 5G NR/Long-Term Evolution (LTE)/Long-Term Evolution Advanced (LTE-A) systems. The 5G NR/LTE/LTE-A network architecture 200 may be called a 5G System (5GS)/Evolved Packet System (EPS) 200 or other appropriate terms. The 5GS/EPS 200 comprises at least one of a UE 201, an RAN 202, a 5G Core Network/Evolved Packet Core (5GC/EPC) 210, a Home Subscriber Server (HSS)/Unified Data Management (UDM) 220 or an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present application can be extended to networks providing circuit switching services or other cellular networks. The RAN comprises the node 203 and other nodes 204. The node 203 provides UE 201-oriented user plane and control plane protocol terminations. The node 203 may be connected to other nodes 204 via an Xn interface (e. g., backhaul)/X2 interface. The node 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The node 203 provides an access point of the 5GC/EPC 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPS), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The node 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMES/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the UE 201 is the first node in the present application.

In one embodiment, the UE 201 is a UE.

In one embodiment, the node 203 corresponds to the second node in the present application.

In one embodiment, the node 203 is the second node in the present application.

In one embodiment, the node 203 is a BaseStation (BS).

In one embodiment, the node 203 is a UE.

In one embodiment, the node 203 is a relay.

In one embodiment, the node 203 is a gateway.

In one embodiment, the node 204 corresponds to the third node in the present application.

In one embodiment, the node 204 is the third node in the present application.

In one embodiment, the node 204 is a BaseStation (BS).

In one embodiment, the node 204 is a UE.

In one embodiment, the node 204 is a relay.

In one embodiment, the node 204 is a gateway.

In one embodiment, the UE supports Terrestrial Network (NTN) transmission.

In one embodiment, the UE supports Non-Terrestrial Network (NTN) transmission.

In one embodiment, the UE supports communications within networks with large latency differences.

In one embodiment, the UE supports Dual Connection (DC) transmission.

In one embodiment, the UE comprises an aircraft.

In one embodiment, the UE comprises a vehicle terminal.

In one embodiment, the UE comprises a vessel.

In one embodiment, the UE comprises an Internet of Things (IoT) terminal.

In one embodiment, the UE comprises an industrial Internet of Things (IoT) terminal.

In one embodiment, the UE comprises a device supporting transmission with low-latency and high-reliability.

In one embodiment, the UE comprises test equipment.

In one embodiment, the UE comprises a signaling tester.

In one embodiment, the base station supports transmission over a non-terrestrial network.

In one embodiment, the base station supports transmission over networks with large latency differences.

In one embodiment, the base station supports transmission over a terrestrial network.

In one embodiment, the base station comprises a Marco Cellular base station.

In one embodiment, the base station comprises a Micro Cell base station.

In one embodiment, the base station comprises a Pico Cell base station.

In one embodiment, the base station comprises a Femtocell.

In one embodiment, the base station comprises a base station supporting large latency differences.

In one embodiment, the base station comprises flight platform equipment.

In one embodiment, the base station comprises satellite equipment.

In one embodiment, the base station comprises a Transmitter Receiver Point (TRP).

In one embodiment, the base station comprises a Centralized Unit (CU).

In one embodiment, the base station comprises a Distributed Unit (DU).

In one embodiment, the base station comprises test equipment.

In one embodiment, the base station comprises a signaling tester.

In one embodiment, the base station comprises an Integrated Access and Backhaul (IAB)-node.

In one embodiment, the base station comprises an IAB-donor.

In one embodiment, the base station comprises an IAB-donor-CU.

In one embodiment, the base station comprises an IAB-donor-DU.

In one embodiment, the base station comprises an IAB-DU.

In one embodiment, the base station comprises an IAB-MT.

In one embodiment, the base station comprises a Base Transceiver Station (BTS).

In one embodiment, the base station comprises a NodeB (NB).

In one embodiment, the base station comprises a gNB.

In one embodiment, the base station comprises an eNB.

In one embodiment, the base station comprises an ng-eNB.

In one embodiment, the base station comprises an en-gNB.

In one embodiment, the relay comprises a relay.

In one embodiment, the relay comprises an L3 relay.

In one embodiment, the relay comprises an L2 relay.

In one embodiment, the relay comprises a router.

In one embodiment, the relay comprises a switcher.

In one embodiment, the relay comprises a UE.

In one embodiment, the relay comprises a base station.

### Embodiment 3

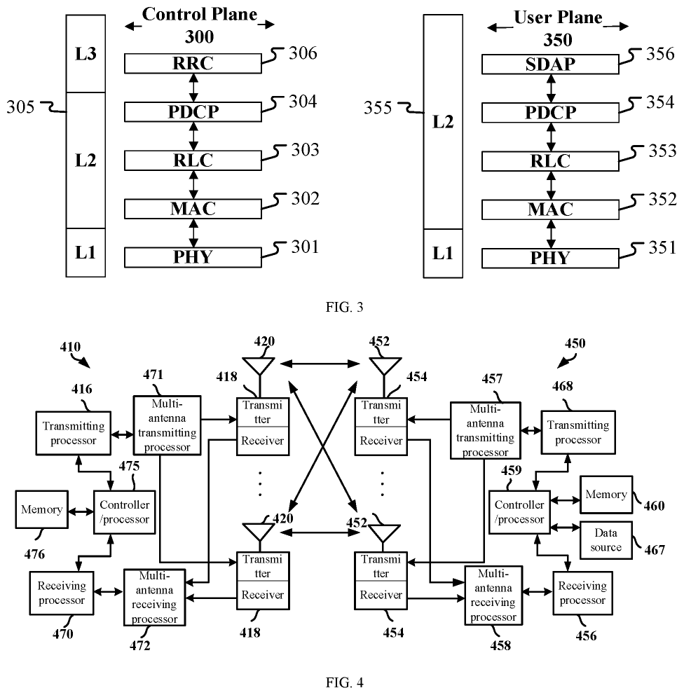

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for the control plane 300 is represented by three layers, which are a layer 1, a layer 2 and a layer 3, respectively. The layer 1 (L1) is the lowest layer and performs signal processing functions of various PHY layers. The L1 is called PHY 301 in the present application L2 305, above the PHY 301, comprises a Medium Access Control (MAC) sublayer 302, a Radio Link Control (RLC) sublayer 303 and a Packet Data Convergence Protocol (PDCP) sublayer 304. The PDCP sublayer 304 provides multiplexing among variable radio bearers and logical channels. The PDCP sublayer 304 provides security by encrypting a data packet and provides support for handover. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating various radio resources (i.e., resources block) in a cell. The MAC sublayer 302 is also in charge of HARQ operation. The RRC sublayer 306 in L3 layer of the control plane 300 is responsible for acquiring radio resources (i.e., radio bearer) and configuring the lower layer with an RRC signaling. The radio protocol architecture of the user plane 350 comprises layer 1 (L1) and layer 2 (L2). In the user plane 350, the radio protocol architecture is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic.

In one embodiment, the radio protocol architecture in FIG. 3 is applicable to the first node in the present application.

In one embodiment, the radio protocol architecture in FIG. 3 is applicable to the second node in the present application.

In one embodiment, the radio protocol architecture in FIG. 3 is applicable to the third node in the present application.

In one embodiment, the first signal in the present application is generated by the RRC 306.

In one embodiment, the first signal in the present application is generated by the MAC 302 or the MAC 352.

In one embodiment, the first signal in the present application is generated by the PHY 301 or the PHY 351.

In one embodiment, the first message in the present application is generated by the RRC 306.

In one embodiment, the first message in the present application is generated by the MAC 302 or the MAC 352.

In one embodiment, the first message in the present application is generated by the PHY 301 or the PHY 351.

In one embodiment, the second message in the present application is generated by the RRC 306.

In one embodiment, the second message in the present application is generated by the MAC 302 or the MAC 352.

In one embodiment, the second message in the present application is generated by the PHY 301 or the PHY 351.

In one embodiment, the first signaling in the present application is generated by the RRC 306.

In one embodiment, the first signaling in the present application is generated by the MAC 302 or the MAC 352.

In one embodiment, the first signaling in the present application is generated by the PHY 301 or the PHY 351.

In one embodiment, the second signaling in the present application is generated by the RRC 306.

In one embodiment, the second signaling in the present application is generated by the MAC 302 or the MAC 352.

In one embodiment, the second signaling in the present application is generated by the PHY 301 or the PHY 351.

In one embodiment, the third signaling in the present application is generated by the RRC 306.

In one embodiment, the third signaling in the present application is generated by the MAC 302 or the MAC 352.

In one embodiment, the third signaling in the present application is generated by the PHY 301 or the PHY 351.

### Embodiment 4

Embodiment 4 illustrates a schematic diagram of a first communication device and a second communication device in the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410 side, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises at least one processor and at least one memory. at least one processor and at least one memory. The at least one memory comprises computer program codes; the at least one memory and the computer program codes are configured to be used in collaboration with the at least one processor, the first communication device 450 at least: receives a first message, the first message is used to determine a first criterion and a second criterion; determines that a first cell meets a target criterion, the target criterion is one of the first criterion or the second criterion; transmits a first signal on the first cell; herein, the first criterion comprises at least one of time information or location information, and the first criterion comprises a measurement result for reference signal(s) of the first cell; the second criterion comprises a measurement result for reference signal(s) of the first cell, and the second criterion does not comprise time information and location information; the first signal is used to establish a connection with the first cell; whether the target criterion is the first criterion or the second criterion is related to whether a radio connection problem occurs at the first node.

In one embodiment, the first communication device 450 comprises at least one processor and at least one memory. a memory that stores a computer readable instruction program. The computer readable instruction program generates an action when executed by at least one processor. The action includes: receiving a first message, the first message being used to determine a first criterion and a second criterion; determining that a first cell meets a target criterion, the target criterion being one of the first criterion or the second criterion; transmitting a first signal on the first cell; herein, the first criterion comprises at least one of time information or location information, and the first criterion comprises a measurement result for reference signal(s) of the first cell; the second criterion comprises a measurement result for reference signal(s) of the first cell, and the second criterion does not comprise time information and location information; the first signal is used to establish a connection with the first cell; whether the target criterion is the first criterion or the second criterion is related to whether a radio connection problem occurs at the first node.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: transmits a first message, the first message is used to determine a first criterion and a second criterion; receives a first signal on a first cell; herein, a first cell meeting a target criterion is determined, the target criterion is one of the first criterion or the second criterion; the first criterion comprises at least one of time information or location information, and the first criterion comprises a measurement result for reference signal(s) of the first cell; the second criterion comprises a measurement result for reference signal(s) of the first cell, and the second criterion does not comprise time information and location information; the first signal is used to establish a connection with the first cell; whether the target criterion is the first criterion or the second criterion is related to whether a radio connection problem occurs in a receiver of the first message.

In one embodiment, the second communication device 410 comprises a memory that stores a computer readable instruction program. The computer readable instruction program generates an action when executed by at least one processor. The action includes: transmitting a first message, the first message being used to determine a first criterion and a second criterion; receiving a first signal on a first cell; herein, a first cell meeting a target criterion is determined, the target criterion is one of the first criterion or the second criterion; the first criterion comprises at least one of time information or location information, and the first criterion comprises a measurement result for reference signal(s) of the first cell; the second criterion comprises a measurement result for reference signal(s) of the first cell, and the second criterion does not comprise time information and location information; the first signal is used to establish a connection with the first cell; whether the target criterion is the first criterion or the second criterion is related to whether a radio connection problem occurs in a receiver of the first message.

In one embodiment, the antenna 452, the receiver 454, the receiving processor 456, and the controller/processor 459 are used to receive a first message; at least one of the antenna 420, the transmitter 418, the transmitting processor 416, or the controller/processor 475 is used to transmit a first message.

In one embodiment, the antenna 452, the transmitter 454, the transmitting processor 468, and the controller/processor 459 are used to transmit a first signal; at least one of the antenna 420, the receiver 418, the receiving processor 470, or the controller/processor 475 is used to receive a first signal.

In one embodiment, the antenna 452, the transmitter 454, the transmitting processor 468, and the controller/processor 459 are used to transmit a second message; at least one of the antenna 420, the receiver 418, the receiving processor 470, or the controller/processor 475 is used to receive a second message.

In one embodiment, the antenna 452, the receiver 454, the receiving processor 456, the controller/processor 459 are used to receive a first signaling; at least one of the antenna 420, the transmitter 418, the transmitting processor 416, or the controller/processor 475 is used to transmit the first signaling.

In one embodiment, the antenna 452, the receiver 454, the receiving processor 456, and the controller/processor 459 are used to receive a second signaling; at least one of the antenna 420, the transmitter 418, the transmitting processor 416, or the controller/processor 475 is used to transmit a second signaling.

In one embodiment, the antenna 452, the receiver 454, the receiving processor 456, and the controller/processor 459 are used to receive a third signaling; at least one of the antenna 420, the transmitter 418, the transmitting processor 416, or the controller/processor 475 is used to transmit a third signaling. In one embodiment, the antenna 452, the receiver 454, the receiving processor 456, and the controller/processor 459 are used to receive a first offset; at least one of the antenna 420, the transmitter 418, the transmitting processor 416, or the controller/processor 475 is used to transmit a first offset.

In one embodiment, the first communication device 450 corresponds to a first node in the present application.

In one embodiment, the second communication device 410 corresponds to a second node in the present application.

In one embodiment, the second communication device 410 corresponds to a third node in the present application.

In one embodiment, the first communication device 450 is a UE.

In one embodiment, the first communication device 450 is a terminal.

In one embodiment, the first communication device 450 is a UE that supports large delay differences.

In one embodiment, the first communication device 450 is a UE that supports NTN.

In one embodiment, the first communication device 450 is an aircraft device.

In one embodiment, the first communication device 450 has a positioning capability.

In one embodiment, the first communication device 450 does not have a positioning capability.

In one embodiment, the first communication device 450 is a UE that supports TN.

In one embodiment, the second communication device 410 is a base station (gNB/eNB/ng-eNB).

In one embodiment, the second communication device 410 is a UE.

In one embodiment, the second communication device 410 is a relay.

In one embodiment, the second communication device 410 is a base station that supports large delay differences.

In one embodiment, the second communication device 410 is a base station that supports NTN.

In one embodiment, the second communication device 410 is satellite equipment.

In one embodiment, the second communication device 410 is flying platform equipment.

In one embodiment, the second communication device 410 is a base station that supports TN.

### Embodiment 5

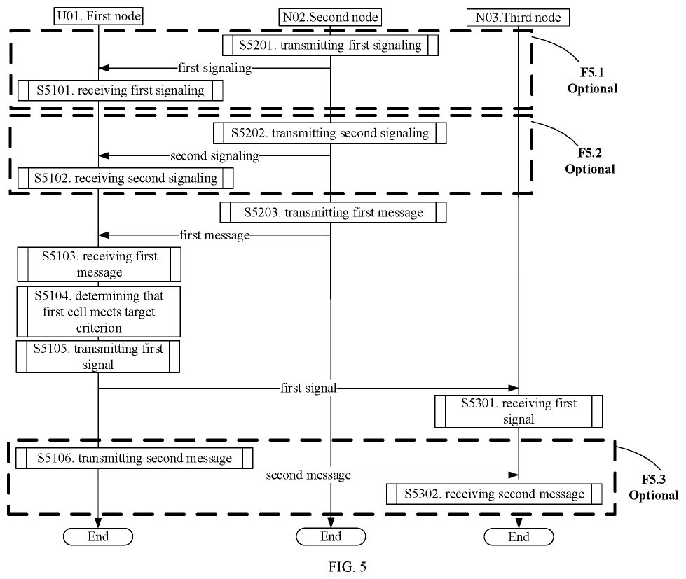

Embodiment 5 illustrates a flowchart of radio signal transmission according to one embodiment in the present application, as shown in FIG. 5. It is particularly underlined that the order illustrated in the embodiment does not put constraints over sequences of signal transmissions and implementations.

The first node U01 receives a first signaling in step S5101, and the first signaling is used to determine a first time length; in step S5102, receives a second signaling, and the second signaling is used to determine a first value; in step S5103, receives a first message, and the first message is used to determine a first criterion and a second criterion; in step S5104, determines that a first cell meets a target criterion, and the target criterion is one of the first criterion or the second criterion; in step 5105, transmits a first signal on the first cell; in step 5106, tmnsmits a second message, the second message indicates the target criterion.

The second node N02 transmits a first signaling in step S5201; transmits a second signaling in step S5202; transmits a first message in step S5203.

The third node N03 receives a first signal in step S5301; receives a second message in step S5302.

In embodiment 5, the first criterion comprises at least one of time information or location information, and the first criterion comprises a measurement result for reference signal(s) of the first cell; the second criterion comprises a measurement result for reference signal(s) of the first cell, and the second criterion does not comprise time information and location information; the first signal is used to establish a connection with the first cell; whether the target criterion is the first criterion or the second criterion is related to whether a radio connection problem occurs at the first node U01.

In one embodiment, the first node U01 is a UE.

In one embodiment, the first node U01 is a terminal.

In one embodiment, the second node N02 is a base station.

In one embodiment, the second node N02 is a relay.

In one embodiment, the second node N02 is a UE.

In one embodiment, the second node N02 is a maintenance base station for a serving cell of the first node N01.

In one embodiment, the second node N02 is a maintenance base station of the second cell.

In one embodiment, the second node N02 is a maintenance base station of a PCell of the first node.

In one embodiment, the second node N02 is a maintenance base station for a source serving cell of the first node.

In one embodiment, the third node N03 is a base station.

In one embodiment, the third node N03 is a relay.

In one embodiment, the third node N03 is a UE.

In one embodiment, the third node N03 is a maintenance base station for a CHO candidate cell.

In one embodiment, the third node N03 comprises a maintenance base station of the first cell.

In one embodiment, the third node N03 is a maintenance base station of the second cell.

In one embodiment, the second node N02 is a maintenance base station for a source serving cell of the first node N01; and the third node N03 is a maintenance base station for a target serving cell of the first node U01.

In one embodiment, the second cell is a PCell.

In one embodiment, the second cell is a serving cell of the first node.

In one embodiment, the second cell is a CHO candidate cell.

In one embodiment, the second cell is a target cell.

In one embodiment, the dotted box F5.1 is optional.

In one embodiment, the dotted box F5.1 exists.

In one embodiment, the dotted box F5.1 does not exist.

In one embodiment, the dotted box F5.2 is optional.

In one embodiment, the dotted box F5.2 exists.

In one embodiment, the dotted box F5.2 does not exist.

In one embodiment, the dotted box F5.3 is optional.

In one embodiment, the dotted box F5.3 exists.

In one embodiment, the dotted box F5.3 does not exist.

In one embodiment, one of the dotted box F5.1 and the dotted box F5.2 exists.

In one embodiment, both the dotted box F5.1 and the dotted box F5.2 exist at the same time.

In one embodiment, both the dotted box F5.1 and the dotted box F5.2 do not exist at the same time.

In one embodiment, the phrase of the second message indicating the target criterion comprises: the second message is used to determine the target criterion.

In one embodiment, the phrase of the second message indicating the target criterion comprises: the second message comprises the target criterion.

In one embodiment, the phrase of the second message indicating the target criterion comprises: the second message explicitly indicates the target criterion.

In one embodiment, the phrase of the second message indicating the target criterion comprises: the second message implicitly indicates the target criterion.

In one embodiment, the phrase of the second message indicating the target criterion comprises: the second message indicates whether the target criterion is the first criterion or the second criterion.

In one embodiment, a receiver of the second message comprises a maintenance base station of the first cell.

In one embodiment, a receiver of the second message comprises a maintenance base station for a current PCell of the first node U01.

In one embodiment, a receiver of the second message comprises the second node N02.

In one embodiment, a receiver of the second message comprises the third node N03.

In one embodiment, a receiver of the second message comprises a node other than the second node N02 and the third node N03.

In one embodiment, the second message is used to report information stored by the first node U01 and requested by the network.

In one embodiment, the second message is an RRC message.

In one subembodiment of the embodiment, the RRC message is a UEInformationResponse message.

In one subembodiment of the embodiment, the RRC message is a ULInformationTransferMRDC message.

In one subembodiment of the embodiment, the RRC message is an RRCReconfigurationComplete message or an RRCConnectionReconfigurationComplete message.

In one embodiment, the second message comprises at least one IE in the RRC message.

In one embodiment, the second message comprises at least one field in the RRC message.

In one embodiment, the second message comprises a field in a UEInformationResponse message.

In one embodiment, the second message is a field in a UEInformationResponse message.

In one embodiment, the second message comprises the target criterion.

In one embodiment, the second message indicates an identifier of the target criterion.

In one embodiment, the second message indicates that the target criterion is for NTN or TN.

In one embodiment, the second message indicates whether the target criterion is related to satellite ephemeris.

In one embodiment, the second message indicates whether the target criterion is related to a location of the first node U01.

In one embodiment, the second message is a Boolean value.

In one embodiment, the second message is a positive integer.

In one embodiment, the second message is a non-negative integer.

In one embodiment, the second message is not greater than 16.

In one embodiment, the second message is not greater than 8.

In one embodiment, the second message is a true value or false value.

In one embodiment, the second message is equal to 0 or 1.

In one embodiment, the second message being set to a value indicates the first criterion, and the second message being set to another value indicates the second criterion, the value being different from the another value.

In one embodiment, the value is equal to 1, and the another value is equal to 0.

In one embodiment, the value is equal to 1, and the another value is equal to 0.

In one embodiment, a name of the value comprises at least one of NTN, condition, cond, criterion, used, or execute, and a name of the another value comprises at least one of TN or condition or cond or criterion or used or execute.

In one embodiment, the second message is triggered by a UEInformationRequest message.

In one embodiment, as a response to receiving a UEInformationRequest message, the second message is transmitted.

In one embodiment, when a UEInformationRequest message is received and a field in the UEInformationRequest message is set to true, the second message is transmitted.

In one subembodiment of the embodiment, a name of the field comprises rlf-ReportReq.

In one subembodiment of the embodiment, a name of the field comprises mobilityHistoryReportReq.

In one subembodiment of the embodiment, a name of the field comprises at least one of ho or ReportReq or Succ, and the field is used to request handover information.

In one embodiment, the first signaling comprises an RRC messages.

In one embodiment, the first signaling comprises an RRCReconfiguration message or an RRCConnectionReconfiguration message.

In one embodiment, the first signaling comprises a SystemInformation message.

In one embodiment, the first signaling comprises an SIB1 message or SystemInformationBlockType1 message.

In one embodiment, the first signaling comprises an IE in an RRC message.

In one embodiment, the first signaling comprises a field in an RRC message.

In one embodiment, the first signaling comprises a field in an RRC message, and a name of the field comprises cellSelectionInfo.

In one embodiment, the phrase that the first signaling is used to determine a first time length comprises: the first signaling explicitly indicates the first time length.

In one embodiment, the phrase that the first signaling is used to determine a first time length comprises: the first signaling implicitly indicates the first time length.

In one embodiment, the phrase that the first signaling is used to determine a first time length comprises: the first time length can be calculated through parameters in the first signaling.

In one embodiment, the phrase that the first signaling is used to determine a first time length comprises: the first time length is configured through the first signaling.

In one embodiment, the first time length is configurable.

In one embodiment, the first time length is pre-configured.

In one embodiment, the first time length shall not exceed 1000 milliseconds (ms).

In one embodiment, the first time length shall not exceed 1000 seconds (s).

In one embodiment, a relation between a time interval for an occurrence of the radio connection problem in the first node U01 and the first time length is used to determine the target criterion; the first time length comprises at least one ms; herein, the dotted box F5.1 exists.

In one embodiment, the phrase of a relation between a time interval for an occurrence of the radio connection problem in the first node U01 and the first time length being used to determine the target criterion comprises: a relation between a time interval for an occurrence of the radio connection problem in the first node U01 and the first time length is used to determine whether the target criterion is the first criterion or the second criterion.

In one embodiment, the phrase of a relation between a time interval for an occurrence of the radio connection problem in the first node U01 and the first time length being used to determine the target criterion comprises: whether the target criterion is the first criterion or the second criterion is related to a size relation of a time interval that the radio connection problem occurs at the first node U01 and the first time length.

In one embodiment, the phrase of a relation between a time interval for an occurrence of the radio connection problem in the first node U01 and the first time length being used to determine the target criterion comprises: a time interval for an occurrence of the radio connection problem in the first node U01 being less than the first time length is used to determine that the target criterion is the first criterion; a time interval between an occurrence of the radio connection problem in the first node U01 being not less than the first time length is used to determine that the target criterion is the second criterion.

In one embodiment, the phrase of a relation between a time interval for an occurrence of the radio connection problem in the first node U01 and the first time length being used to determine the target criterion comprises: a time interval for an occurrence of the radio connection problem in the first node U01 not being less than the first time length is used to determine that the target criterion is the first criterion; a time interval for an occurrence of the radio connection problem in the first node U01 being less than the first time length is used to determine that the target criterion is the second criterion.

In one embodiment, the meaning of the not being less than comprises being greater than.

In one embodiment, the meaning of the not being less than comprises being greater than or equal to.

In one embodiment, the second signaling comprises an RRC messages.

In one embodiment, the second signaling comprises an RRCReconfiguration message or an RRCConnectionReconfiguration message.

In one embodiment, the second signaling comprises a SystemInformation message.

In one embodiment, the second signaling comprises an SIB1 message.

In one embodiment, the second signaling comprises an IE in an RRC message.

In one embodiment, the second signaling comprises a field in an RRC message.

In one embodiment, the second signaling comprises a field in an RRC message, and a name of the field comprises cellSelectionInfo.

In one embodiment, the second signaling is used to determine whether the target criterion is a threshold of the first criterion or the second criterion.

In one embodiment, the phrase of the second signaling being used to determine a first value comprises: the second signaling explicitly indicates the first value.

In one embodiment, the phrase of the second signaling being used to determine a first value comprises: the second signaling implicitly indicates the first value.

In one embodiment, the phrase of the second signaling being used to determine a first value comprises: the first value can be calculated through parameters in the second signaling.

In one embodiment, the phrase of the second signaling being used to determine a first value comprises: a first value is configured through the second signaling.

In one embodiment, the first value is configurable.

In one embodiment, the first value is pre-configured.

In one embodiment, the first value is not greater than 64.

In one embodiment, the first value is not greater than 16.

In one embodiment, the first value is not greater than 8.

In one embodiment, the first value is equal to 2.

In one embodiment, the first value is equal to 1.

In one embodiment, a relation between a number of times that the radio connection problem occurs at the first node U01 and the first value is used to determine the target criterion; the first value is a non-negative integer. herein, the dotted box F5.2 exists.

In one embodiment, the phrase of a relation between a number of times that the radio connection problem occurs at the first node U01 and the first value being used to determine the target criterion comprises: a relation between a number of times between an occurrence of the radio connection problem in the first node U01 and the first value is used to determine whether the target criterion is the first criterion or the second criterion.

In one embodiment, the phrase of a relation between a number of times that the radio connection problem occurs at the first node U01 and the first value being used to determine the target criterion comprises: whether the target criterion is the first criterion or the second criterion is related to a size a relation between a number of times that the radio connection problem occurs at the first node U01 and the first value.

In one embodiment, the phrase of a relation between a number of times that the radio connection problem occurs at the first node U01 and the first value being used to determine the target criterion comprises: an occurrence of the radio connection problem in the first node U01 being less than the first value is used to determine that the target criterion is the first criterion; an occurrence of the radio connection problem in the first node U01 not being less than the first value is used to determine that the target criterion is the second criterion.

In one embodiment, the phrase of a relation between a number of times that the radio connection problem occurs at the first node U01 and the first value being used to determine the target criterion comprises: an occurrence of the radio connection problem in the first node U01 not being less than the first value is used to determine that the target criterion is the first criterion; an occurrence of the radio connection problem in the first node U01 being less than the first value is used to determine that the target criterion is the second criterion.

In one embodiment, the phrase of a number of times that the radio connection problem occurs at the first node U01 comprises: a number of continuous radio connection problems that occur on a same cell for the first node U01.

In one embodiment, the phrase of a number of times that the radio connection problem occurs at the first node U01 comprises: a number of continuous radio connection problems that occur on different cells for the first node U01.

In one embodiment, the phrase of a number of times that the radio connection problem occurs at the first node U01 comprises: a number of continuous radio connection problems that occur on a same cell or different cells for the first node U01.

In one embodiment, a number of times the radio connection problems occur at the first node U01 refers to a number of times of continuous occurrence of the radio connection problem.

In one embodiment, when a number of times the radio connection problem occurs at the first node U01 is greater than 1, reasons for any two radio connection problems are the same.

In one embodiment, when a number of times the radio connection problem occurs at the first node U01 is greater than 1, reasons for any two radio connection problems are different.

In one embodiment, when a number of times the radio connection problem occurs at the first node U01 is greater than 1, reasons for any two radio connection problems are the same or different.

In one embodiment, one reason for the radio connection problem is RLF.

In one embodiment, one reason for the radio connection problem is HOF.

In one embodiment, one reason for the radio connection problem is Synchronization reconfiguration failure.

### Embodiment 6

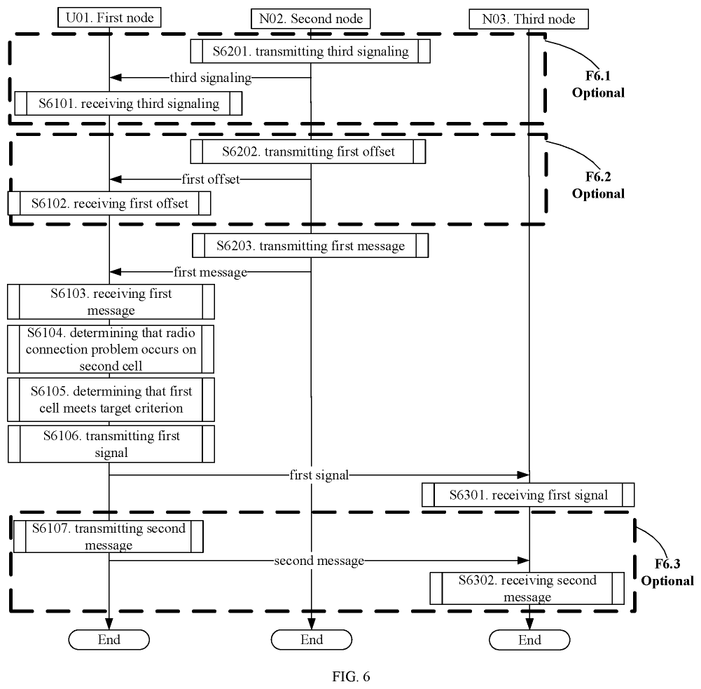

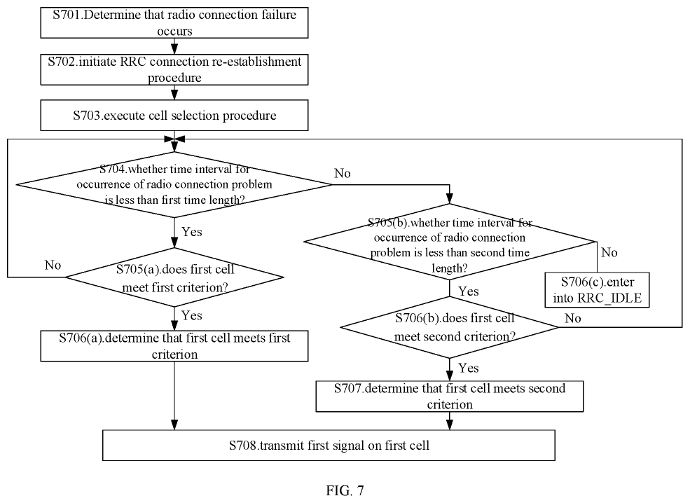

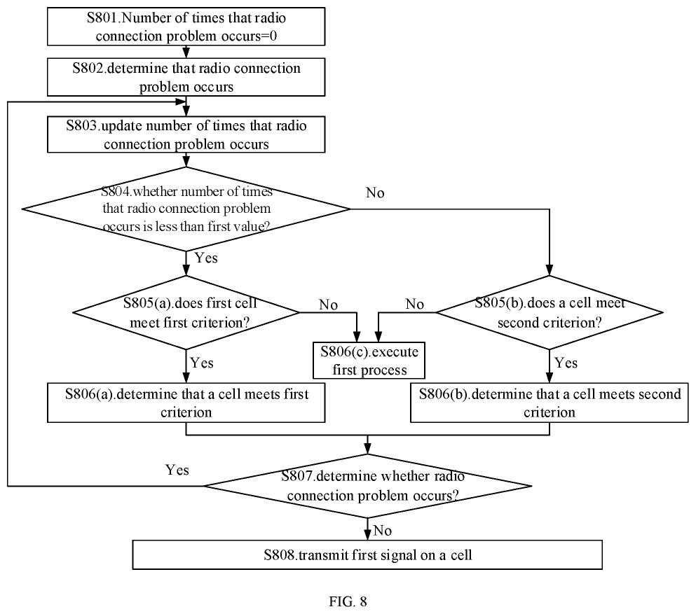

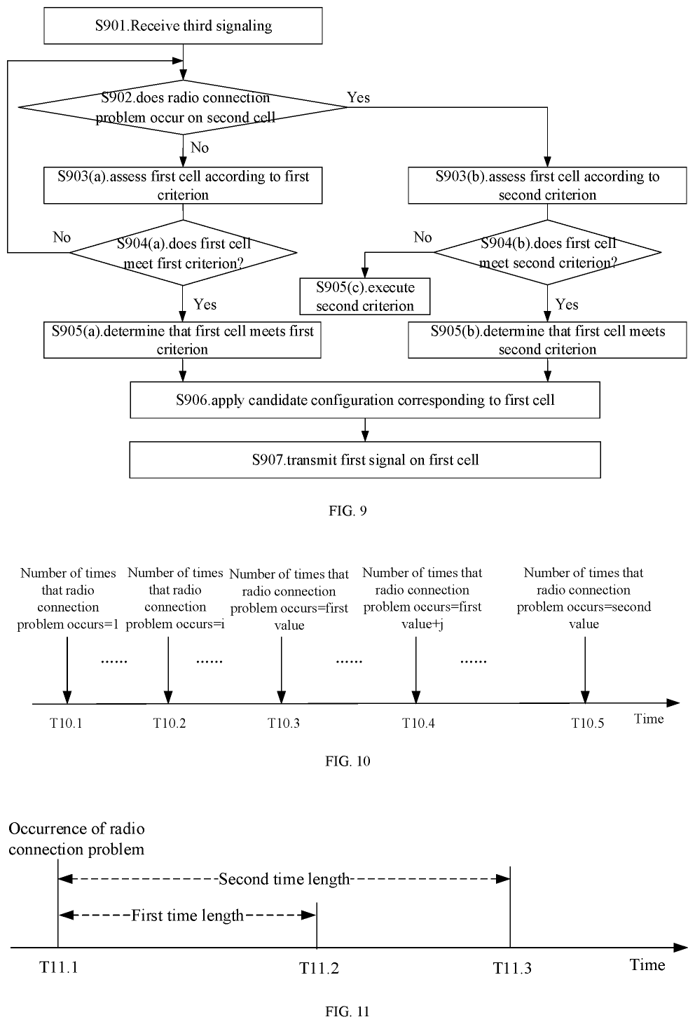

Embodiment 6 illustrates a flowchart of radio signal transmission according to another embodiment of the present application, as shown in FIG. 6. It is particularly underlined that the order illustrated in the embodiment does not put constraints over sequences of signal transmissions and implementations.

The first node U01 receives a third signaling in step S6101, the third signaling indicates a first candidate cell group, the first candidate cell group comprises at least one candidate cell, each candidate cell in the first candidate cell group is associated with a candidate condition and a candidate configuration; in step S6102, receives a first offset; in step S6103, receives a first message, and the first message is used to determine a first criterion and a second criterion; in step S6104, determines an occurrence of radio connection problem on a second cell; in step S6105, determines that a first cell meets a target criterion, the target criterion is one of the first criterion or the second criterion; in step 6106, transmits a first signal on the first cell; in step 6107, transmits a second message, the second message indicates the target criterion.

The second node N02 transmits a third signaling in step S6201; in step S6202, transmits a first offset; transmits first information in step S6203.

The third node N03 receives a first signal in step S6301; receives a second message in step S6302.

In embodiment 6, the first criterion comprises at least one of time information or location information, and the first criterion comprises a measurement result for reference signal(s) of the first cell; the second criterion comprises a measurement result for reference signal(s) of the first cell, and the second criterion does not comprise time information and location information; the first signal is used to establish a connection with the first cell; whether the target criterion is the first criterion or the second criterion is related to whether a radio connection problem occurs at the first node U01.

In one embodiment, the dotted box F6.1 is optional.

In one embodiment, the dotted box F6.1 exists.

In one embodiment, the dotted box F6.1 does not exist.

In one embodiment, the dotted box F6.2 is optional.

In one embodiment, the dotted box F6.2 exists.

In one embodiment, the dotted box F6.2 does not exist.

In one embodiment, the dotted box F6.3 is optional.

In one embodiment, the dotted box F6.3 exists.

In one embodiment, the dotted box F6.3 does not exist.

In one embodiment, both the dotted box F6.1 and the dotted box F6.2 do not exist at the same time.

In one subembodiment of the embodiment, a first receiver receives a first message, and the first message is used to determine a first criterion and a second criterion; determines that the radio connection problem occurs on a second cell; determines that a first cell meets a target criterion, the target criterion is one of the first criterion or the second criterion; a first transmitter transmits a first signal on the first cell; herein, the behavior of determining that the radio connection problem occurs on a second cell is used to determine that a priority of the first cell is higher than a priority of the second cell; the first criterion comprises at least one of time information or location information, and the first criterion comprises a measurement result for reference signal(s) of the first cell; the second criterion comprises a measurement result for reference signal(s) of the first cell, and the second criterion does not comprise time information and location information; the first signal is used to establish a connection with the first cell; whether the target criterion is the first criterion or the second criterion is related to whether a radio connection problem occurs at the first node U01; the priority of the first cell being higher than the priority of the second cell is used to determine that the second criterion does not comprise time information and location information; the first cell is different from the second cell.

In one embodiment, the dotted box F6.1 exists, and the dotted box F6.2 does not exist.

In one subembodiment of the embodiment, a first receiver receives a first message, and the first message is used to determine a first criterion and a second criterion; receives a third signaling, the third signaling indicates a first candidate cell group, the first candidate cell group comprises at least one candidate cell, each candidate cell in the first candidate cell group is associated with a candidate condition and a candidate configuration; determines that a first cell meets a target criterion, the target criterion is one of the first criterion or the second criterion; a first transmitter transmits a first signal on the first cell; herein, the first criterion comprises at least one of time information or location information, and the first criterion comprises a measurement result for reference signal(s) of the first cell; the second criterion comprises a measurement result for reference signal(s) of the first cell, and the second criterion does not comprise time information and location information; the first signal is used to establish a connection with the first cell; whether the target criterion is the first criterion or the second criterion is related to whether a radio connection problem occurs at the first node U01; the first cell is a candidate cell in the first candidate cell group.

In one embodiment, both the dotted box F6.1 and dotted box F6.2 exist at the same time.

In one subembodiment of the embodiment, a first receiver receives a first message, and the first message is used to determine a first criterion and a second criterion; receives a third signaling, the third signaling indicates a first candidate cell group, the first candidate cell group comprises at least one candidate cell, each candidate cell in the first candidate cell group is associated with a candidate condition and a candidate configuration; determines that the radio connection problem occurs on a second cell; determines that a first cell meets a target criterion, the target criterion is one of the first criterion or the second criterion; a first transmitter transmits a first signal on the first cell; herein, the behavior of determining that the radio connection problem occurs on a second cell is used to determine that a priority of the first cell is higher than a priority of the second cell; the first criterion comprises at least one of time information or location information, and the first criterion comprises a measurement result for reference signal(s) of the first cell; the second criterion comprises a measurement result for reference signal(s) of the first cell, and the second criterion does not comprise time information and location information; the first signal is used to establish a connection with the first cell; whether the target criterion is the first criterion or the second criterion is related to whether a radio connection problem occurs at the first node U01; the priority of the first cell being higher than the priority of the second cell is used to determine that the second criterion does not comprise time information and location information; the first cell is different from the second cell; the first cell is a candidate cell in the first candidate cell group.

In one embodiment, the phrase of the first cell being different from the second cell comprises: the first cell not being the second cell.

In one embodiment, the phrase of the first cell being different from the second cell comprises: the first cell and the second cell not being the same cell.

In one embodiment, the phrase of the first cell being different from the second cell comprises: the first cell is a cell other than the second cell.

In one embodiment, the first cell is a CHO candidate cell, and the second cell is a PCell.

In one embodiment, the first cell is a CHO candidate cell, and the second cell is another CHO candidate cell.

In one embodiment, the first cell is a CHO candidate cell, and the second cell is a target cell.

In one embodiment, the first cell is a cell determined through cell selection process, and the second cell is a PCell.

In one embodiment, the first cell is a cell determined through cell selection process, and the second cell is a CHO candidate cell.

In one embodiment, the first cell is a cell determined through cell selection process, and the second cell is a target cell.

In one embodiment, the behavior of determining an occurrence of the radio connection problem on a second cell comprises: assuming that RLF is detected in the second cell; herein, the second cell is a PCell.

In one embodiment, the behavior of determining an occurrence of the radio connection problem on a second cell comprises: assuming that RLF is detected in a cell group to which the second cell belongs, and the cell group to which the second cell belongs is an MCG; herein, the second cell is a PCell.

In one embodiment, the behavior of determining an occurrence of the radio connection problem on a second cell comprises: assuming a CHOF for the second cell; herein, the second cell is a CHO candidate cell.

In one embodiment, the behavior of determining an occurrence of the radio connection problem on a second cell comprises: assuming a HOF for the second cell; herein, the second cell is a target cell.

In one embodiment, the phrase of the behavior of determining that the radio connection problem occurring on a second cell is used to determine that a priority of the first cell is higher than a priority of the second cell comprises: as a response to the behavior of determining an occurrence of the radio connection problem on a second cell, the priority of the first cell is higher than the priority of the second cell.

In one embodiment, the phrase of the behavior of determining that the radio connection problem occurring on a second cell is used to determine that a priority of the first cell is higher than a priority of the second cell comprises: when an occurrence of the radio connection problem on the second cell is determined, the priority of the first cell is higher than the priority of the second cell.

In one embodiment, the phrase of the behavior of determining that the radio connection problem occurring on a second cell is used to determine that a priority of the first cell is higher than a priority of the second cell comprises: the behavior of determining an occurrence of the radio connection problem on a second cell resulting in that the priority of the first cell is higher than the priority of the second cell.

In one embodiment, the phrase of a priority of the first cell being greater than a priority of the second cell comprises: ranking of the first cell is higher than ranking of the second cell.

In one embodiment, the phrase of a priority of the first cell being higher than a priority of the second cell comprises: the second cell is a cell in a CHO candidate cell list, and the first cell not being a cell in the CHO candidate cell list is used to determine that the priority of the first cell is higher than the priority of the second cell.

In one embodiment, the phrase of a priority of the first cell being higher than a priority of the second cell comprises: deleting the second cell from a CHO candidate cell list is used to determine that the priority of the first cell is higher than the priority of the second cell.

In one embodiment, the first cell is a cell with the highest priority.

In one embodiment, the first cell is a cell with a second highest priority, and a cell with the highest priority is not the second cell.

In one embodiment, the phrase of the priority of the first cell being higher than the priority of the second cell being used to determine that the second criterion does not comprise time information and location information comprises: the priority of the first cell being higher than the priority of the second cell is used to determine that the first cell is determined not according to time information and location information.

In one embodiment, the phrase of the priority of the first cell higher than the priority of the second cell being used to determine that the second criterion does not comprise time information and location information comprises: the priority of the first cell being higher than the priority of the second cell is used to determine a priority of the first cell is determined not according to time information and location information.

In one embodiment, the phrase of the priority of the first cell higher than the priority of the second cell being used to determine that the second criterion does not comprise time information and location information comprises: the second criterion is related to a priority of a cell and is unrelated to the time information and the location information.

In one embodiment, the phrase of the priority of the first cell higher than the priority of the second cell being used to determine that the second criterion does not comprise time information and location information comprises: the second criterion comprises that the priority of the first cell is higher than the priority of the second cell.

In one embodiment, the phrase of the priority of the first cell higher than the priority of the second cell being used to determine that the second criterion does not comprise time information and location information comprises: the second criterion comprises selecting a cell satisfying cell selection criterion in cells other than the second cell.

In one embodiment, the phrase of the priority of the first cell higher than the priority of the second cell being used to determine that the second criterion does not comprise time information and location information comprises: the second criterion comprises determining a candidate cell that meets execution condition among candidate cells other than the second cell.

In one embodiment, if the first cell satisfies the first-type inequality but does not satisfy the second-type inequality, the second cell satisfies the first-type inequality and satisfies the second-type inequality, as the priority of the first cell is higher than that the priority of the second cell, the second cell is selected, and the first cell is not selected.

In one embodiment, the third signaling is used to add or modify configuration of conditional reconfiguration.

In one embodiment, the conditional reconfiguration is Conditional Handover (CHO).

In one embodiment, the conditional reconfiguration is PCell Conditional PCell Change (CPC).

In one embodiment, the third signaling comprises an RRC messages.

In one embodiment, the third signaling comprises an RRCReconfiguration message or an RRCConnectionReconfiguration message.

In one embodiment, the third signaling comprises an IE in an RRC message, and a name of the IE comprises ConditionalReconfiguration.

In one embodiment, the third signaling comprises an IE in an RRC message, and a name of the IE comprises CondReconfigToAddModList or CondReconfigurionToAddModList.

In one embodiment, the third signaling comprises an IE in an RRC message, and a name of the IE comprises CondReconfigId or condReconfigurationId.

In one embodiment, the third signaling comprises an RRC message in an RRC message, and a name of the RRC message comprises RRCReconfiguration or RRCConnectionReconfiguration.

In one embodiment, the third signaling comprises a field in an RRC message, and a name of the field comprises condExecutionCond or triggerCondition.

In one embodiment, the third signaling comprises a field in an RRC message, and a name of the field comprises condRRCReconfig or condReconfigurationToApply.

In one embodiment, the third signaling comprises ConditionalReconfigurement, and the ConditionalReconfigurement comprises CondReconfigToAddModList or CondReconfigurementToAddModList.

In one embodiment, the phrase of the third signaling indicating a first candidate cell group comprises: the third signaling being used to configure the first candidate cell group.

In one embodiment, the phrase of the third signaling indicating a first candidate cell group comprises: the third signaling comprises a configuration of at least one candidate cell in the first candidate cell group.

In one embodiment, the phrase of the third signaling indicating a first candidate cell group comprises: the third signaling comprises a configuration of all candidate cells in the first candidate cell group.

In one embodiment, the phrase of the third signaling indicating a first candidate cell group comprises: the third signaling comprises a configuration of at least the first cell in the first candidate cell group.

In one embodiment, the phrase of the third signaling indicating a first candidate cell group comprises: the third signaling comprises the first candidate cell group.

In one embodiment, the phrase of the third signaling indicating a first candidate cell group comprises: the third signaling comprises a physical cell identifier (PCI) of each candidate cell in the first candidate cell group.

In one embodiment, the phrase of the first candidate cell group comprising at least one candidate cell comprises: the first candidate cell group comprises a candidate cell or multiple candidate cells.

In one embodiment, the phrase of the first candidate cell group comprising at least one candidate cell comprises: the first candidate cell group comprises at least the first cell.

In one embodiment, the first candidate cell group comprises at most 8 candidate cells.

In one embodiment, the first candidate cell group comprises at most 16 candidate cells.

In one embodiment, the first candidate cell group comprises at most 32 candidate cells.

In one embodiment, each candidate cell in the first candidate cell group corresponds to a CondReconfigId, and the CondReconfigId is a positive integer.

In one subembodiment of the above embodiment, the conditional reconfiguration identifier is not greater than 8.

In one subembodiment of the above embodiment, the conditional reconfiguration identifier is not greater than 16.

In one subembodiment of the above embodiment, the conditional reconfiguration identifier is not greater than 32.

In one embodiment, the phrase of each candidate cell in the first candidate cell group being associated with a candidate condition and a candidate configuration comprises: each candidate cell in the first candidate cell group respectively corresponds to a candidate condition and a candidate configuration.

In one embodiment, a candidate condition corresponding to a candidate cell is associated with at least one Meas Id (MeasId).

In one embodiment, a candidate condition corresponding to a candidate cell comprises a CHO triggering event.

In one embodiment, a candidate condition corresponding to a candidate cell comprises a measurement report triggering event.

In one embodiment, the first criterion comprises a candidate condition corresponding to the first cell; the second criterion comprises another candidate condition corresponding to the first cell, and the first cell is a candidate cell in the first candidate cell group.

In one embodiment, the candidate condition is configured through a field in the third signaling, and a name of the field comprises condExecutionCond or triggerCondition.

In one embodiment, the candidate configuration is configured through a field in the third signaling, and a name of the field comprises condRRCReconfig or condReconfigurementToApply.

In one embodiment, a candidate condition and a candidate configuration associated with a candidate cell correspond to a condReconfigId or condReconfigurionId.

In one embodiment, a candidate condition corresponding to the first cell comprises the first criterion and the second criterion.

In one subembodiment of the above embodiment, when the radio connection problem does not occur in the first node U01, a candidate condition corresponding to the first cell is the first criterion.

In one subembodiment of the above embodiment, when the radio connection problem occurs at the first node U01, a candidate condition corresponding to the first cell is the second criterion.

In one embodiment, as a response to the behavior of determining that a first cell meets a target criterion, a candidate configuration corresponding to the first cell is applied.

In one embodiment, the phrase of the first cell being a candidate cell in the first candidate cell group comprises: the first cell is a CHO candidate cell.

In one embodiment, the phrase of the first cell being a candidate cell in the first candidate cell group comprises: the first cell is the only CHO candidate cell.

In one embodiment, the phrase of the first cell being a candidate cell in the first candidate cell group comprises: the first cell is one of multiple CHO candidate cells.

In one embodiment, the phrase of the first cell being a candidate cell in the first candidate cell group comprises: the first cell is an only candidate cell satisfying a candidate condition.

In one embodiment, the phrase of the first cell being a candidate cell in the first candidate cell group comprises: the first cell is a candidate cell among multiple candidate cells satisfying a candidate condition.

In one embodiment, the first offset is measured by dBm.

In one embodiment, the first offset is measured by m.

In one embodiment, the first offset is measured by ms.

In one embodiment, when the radio connection problem occurs at the first node U01, the target criterion is related to both a candidate condition corresponding to the first cell and the first offset, and the target criterion is the second criterion.

In one embodiment, when the radio connection problem does not occur at the first node U01, the target criterion is related to a candidate condition corresponding to the first cell, and the target criterion is the first criterion.

In one embodiment, a sum of the candidate condition corresponding to the first cell and the first offset is used to determine the target criterion.

In one embodiment, a difference value of the candidate condition corresponding to the first cell and the first offset is used to determine the target criterion.

In one embodiment, a first-type inequality constraint in the candidate condition corresponding to the first cell comprises: Mn+Ofn+Ocn−Hys>Mp+Ofp+Ocp+Off, and a first-type inequality constraint in the target criterion comprises: Mn+Ofn+Ocn−Hys+the first offset>Mp+Ofp+Ocp+Off.

In one embodiment, a first-type inequality constraint in the candidate condition corresponding to the first cell comprises: Mn+Ofn+Ocn−Hys>Thresh, and a first-type inequality constraint in the target criterion comprises: Mn+Ofn+Ocn−Hys+the first offset>Thresh.

In one embodiment, a first-type inequality constraint in the candidate condition corresponding to the first cell comprises: Mp+Hys<Thresh1 and Mn+Ofn+Ocn−Hys>Thresh2, and a first-type inequality constraint in the target criterion comprises: Mp+Hys<Thresh1 and Mn+Ofn+Ocn−Hys+the first offset>Thresh2.

In one embodiment, a first receiver receives a third signaling, the third signaling indicates a first candidate cell group, the first candidate cell group comprises at least one candidate cell, each candidate cell in the first candidate cell group is associated with a candidate condition and a candidate configuration; receives a first message, the first message is used to determine a first criterion and a second criterion; determines that a first cell meets a target criterion; a first transmitter, as a response to the behavior of determining that a first cell meets a target criterion, transmits a first signal on the first cell; herein, the target criterion is a first criterion; the first cell is a candidate cell in the first candidate cell group; the first criterion comprises at least one of time information or location information, and the first criterion comprises a measurement result for reference signal(s) of the first cell; the second criterion comprises a measurement result for reference signal(s) of the first cell, and the second criterion does not comprise time information and location information; the first signal is used to establish a connection with the first cell; a radio connection problem does not occur in the first node U01.

In one embodiment, a first receiver receives a third signaling, the third signaling indicates a first candidate cell group, the first candidate cell group comprises at least one candidate cell, each candidate cell in the first candidate cell group is associated with a candidate condition and a candidate configuration; receives a first message, the first message is used to determine a first criterion and a second criterion; determines that the radio connection problem occurs on a second cell; determines that a first cell meets a target criterion; a first transmitter, as a response to the behavior of determining that a first cell meets a target criterion, transmits a first signal on the first cell; herein, the target criterion is the second criterion; the first cell is a candidate cell in the first candidate cell group; the first criterion comprises at least one of time information or location information, and the first criterion comprises a measurement result for reference signal(s) of the first cell; the second criterion comprises a measurement result for reference signal(s) of the first cell, and the second criterion does not comprise time information and location information; the first signal is used to establish a connection with the first cell.

In one embodiment, the first cell is an NTN cell.

In one embodiment, the first cell is a TN cell.

In one embodiment, the second cell is an NTN cell.

### Embodiment 7

Embodiment 7 illustrates a flowchart of a relation between a time interval for an occurrence of a radio connection problem in a first node and a first time length being used to determine a target criterion according to one embodiment of the present application.

In embodiment 7, the first node in step S701 determines an occurrence of radio connection failure; in step S702, as a response to the behavior of determining that RLF occurs, initiates an RRC connection re-establishment procedure; in step S703, as a response to the behavior of initiating an RRC connection re-establishment procedure, executes a cell selection process; in step S704, judges whether a time interval for an occurrence of the radio connection failure in the first node is less than a first time length; when a time interval of the radio connection failure in the first node is less than the first time length, proceeds to step S705(a), otherwise, proceeds to step S705(b); in the step S705(a), judges whether a first cell meets a first criterion, when the first cell meets the first criterion, proceeds to step S706(a), otherwise returns to step S704; in step S705(b), judges whether a time interval for an occurrence of the radio connection problem at the first node is less than a second time length; when a time interval for an occurrence of the radio connection problem at the first node is less than the second time length, proceeds to step S706(b); otherwise, proceeds to step S706(c); in the step S706(a), determines that the first cell meets the first criterion; in step S706(b), judges whether the first cell meets the second criterion; when the first cell meets the second criterion, proceeds to step S707; otherwise, returns to step S704; in the step S706(c), enters into RRC_IDLE status; in step S708, transmits a first signal on the first cell.

In one embodiment, the phrase of whether the target criterion is the first criterion or the second criterion being related to whether radio connection problem occurs at the first node comprises: whether the target criterion is the first criterion or the second criterion is related to a relation between a time interval for an occurrence of the radio connection problem at the first node and the first time length.

In one embodiment, the phrase of whether the target criterion is the first criterion or the second criterion being related to whether radio connection problem occurs at the first node comprises: when a time interval for an occurrence of the radio connection failure in the first node is less than the first time length, the target criterion is the first criterion; when a time interval for an occurrence of the radio connection failure in the first node is not less than the first time length, the target criterion is the second criterion.

In one embodiment, the behavior of initiating an RRC connection re-establishment procedure comprises: starting timer T331.

In one embodiment, the behavior of initiating an RRC connection re-establishment procedure comprises: if timer T310 is running, stopping timer T310.

In one embodiment, the behavior of initiating an RRC connection re-establishment procedure comprises: if timer T312 is running, stopping timer T312.

In one embodiment, the behavior of initiating an RRC connection re-establishment procedure comprises: starting timer T311.

In one embodiment, the behavior of initiating an RRC connection re-establishment procedure comprises: if the first node is not configured with conditionalReconfiguration, resetting MAC.

In one embodiment, the behavior of initiating an RRC connection re-establishment procedure comprises: if the first node is not configured with conditionalReconfiguration, suspending all RBs other than SRB0.

### Embodiment 8

Embodiment 8 illustrates a flowchart of a relation between a number of times that a radio connection problem occurs at a first node and a first value being used to determine a target criterion according to one embodiment of the present application.

In Embodiment 8, the first node determines that a number of times a radio connection problem occurs is equal to 0; in step S802, determines that the radio connection problem occurs; in step S803, updates a number of times the radio connection problem occurs; in step S804, judges whether a number of times the radio connection problem occurs at the first node is less than a first value; when a number of times the radio connection problem occurs at the first node is less than the first value, proceeds to step S805(a); otherwise, proceeds to step S805(b); in the step S805(a), judges whether there is a cell meeting a first criterion; when there is a cell meeting the first criterion, proceeds to step S806(a); otherwise, proceeds to step S806(c); in the step S805(b), judges whether there is a cell that meets a second criterion; when there is a cell that meets the second criterion, proceeds to step S806(a); otherwise, proceeds to step S806(b); in the step S806(a), determines that the cell meets the first criterion; in the step S806(b), determines that the cell meets the second criterion; in the step S806(c), executes a first process; in step S807, judges whether the radio connection problem occurs; when it is determined that the radio connection problem occurs, returns back to the step S803; otherwise, proceeds to step S808; in the step S808, transmits a first signal on the cell.

In one embodiment, the phrase of whether the target criterion is the first criterion or the second criterion being related to whether radio connection problem occurs at the first node comprises: whether the target criterion is the first criterion or the second criterion is related to a relation between a number of times that the radio connection problem occurs at the first node and the first value.

In one embodiment, the phrase of whether the target criterion is the first criterion or the second criterion being related to whether radio connection problem occurs at the first node comprises: when a number of times that the radio connection problem occurs at the first node is less than the first value, the target criterion is the first criterion; when a number of times that the radio connection problem occurs at the first node is not less than the first value, the target criterion is the second criterion.

In one embodiment, the behavior of executing a first process comprises: entering into RRC_IDLE state.

In one embodiment, the behavior of executing a first process comprises: returning back to step S804.

In one embodiment, the behavior of executing a first process comprises: judging whether a number of times the radio connection problem occurs at the first node is less than a second value; herein, a number of times the radio connection problem occurs at the first node is not less than the first value.

In one subembodiment of the above embodiment, when a number of radio connection problems occurring at the first node is less than the second value, return to step S805 (b).

In one subembodiment of the above embodiment, when a number of radio connection problems occurring at the first node is not less than the second value, enter into RRC_IDLE state.

In one subembodiment of the above embodiment, when a number of radio connection problems occurring at the first node is not less than the second value, enter into RRC INACTIVE state.

In one embodiment, the behavior of executing a first process comprises: return to a source cell of the first node; herein, the radio connection failure is HOF, and the first cell is a target cell.

In one embodiment, the behavior of executing a first process comprises: return to a source cell of the first node; herein, the radio connection failure is conditional handover failure (CHOF), and the first cell is a CHO candidate cell that meets execution condition.

In one embodiment, the first process when entering step S806(c) from step S805(a) is the same as the first process when entering step S806(c) from step S805(b).

In one embodiment, the first process when entering step S806(c) from step S805(a) is different from the first process when entering step S806(c) from step S805(b).

In one embodiment, the step S801 and step S803 are implemented based on a UE.

In one embodiment, the step S801 and step S803 are implemented through a counter.

In one embodiment, the behavior of updating a number of times that the radio connection problem occurs comprises: increasing a number of times that the radio connection problem occurs by 1.

In one embodiment, the behavior of updating a number of times that the radio connection problem occurs comprises: increasing the counter by 1.

### Embodiment 9

Embodiment 9 illustrates a flowchart of a relation between a number of times that a radio connection problem occurs at a first node and a first value being used to determine a target criterion according to one embodiment of the present application.

In embodiment 9, the first node in step S901 receives a third signaling, the third signaling indicates a first candidate cell group, the first candidate cell group comprises at least one candidate cell, each candidate cell in the first candidate cell group is associated with a candidate condition and a candidate configuration; in step S902, judges whether a radio connection problem occurs on a second cell at the first node; when the radio connection problem occurs on the second cell at the first node, enters into step S903(b), otherwise enters into step S903(a); in the step S903(a), assesses a first cell according to a first criterion; in the step S903(b), assesses a first cell according to a second criterion; in step S904 (a), judges whether a first cell meets a first criterion; when the first cell meets the first criterion, enters into step S905 (a), otherwise returns back to step S902; in step S904(b), judges whether the first cell meets a second criterion; when the first cell meets the second criterion, proceeds to step S905(b); otherwise, proceeds to step S905(c); in step S905(a), determines that the first cell meets the first criterion; in step S905(b), determines that the first cell meets the second criterion; in step S905(c), executes a second process; in step S906, applies a candidate configuration corresponding to the first cell; in step S907, transmits a first signal on the first cell; herein, the first criterion comprises at least one of time information or location information, and the first criterion comprises a measurement result for reference signal(s) of the first cell; the second criterion comprises a measurement result for reference signal(s) of the first cell, and the second criterion does not comprise time information and location information; the first signal is used to establish a connection with the first cell; the first cell is a candidate cell in the first candidate cell group.

In one embodiment, the phrase of whether the target criterion is the first criterion or the second criterion being related to whether radio connection problem occurs at the first node comprises: when the radio connection problem occurs on the second cell at the first node, the target criterion is the second criterion; when the radio connection problem does not occur on the second cell at the first node, the target criterion is the first criterion.

In one embodiment, the behavior of executing a second process comprises: entering into RRC_IDLE state.

In one embodiment, the behavior of executing a second process comprises: executing an RRC connection re-establishment procedure.

In one embodiment, the behavior of executing a second process comprises: returning to step S903(b).

In one embodiment, if the radio connection problem does not occur on the second cell, the first node assesses the first cell according to the first criterion; if the radio connection problem occurs on the second cell, the first node assesses the first cell according to the second criterion.

In one subembodiment of the above embodiment, the first criterion is a CHO execution condition, and the second criterion is a CHO execution condition.

In one subembodiment of the above embodiment, the first criterion is a CHO execution condition, and the second criterion is a cell selection criterion.

In one embodiment, as a response to the behavior of determining that the radio connection problem occurs on a second cell, initiate an RRC connection re-establishment procedure; as a response to the behavior of initiating an RRC connection re-establishment procedure, execute a cell selection process.

In one subembodiment of the embodiment, the behavior of executing a cell selection process comprises: assessing the first cell according to the second criterion.

In one subembodiment of the embodiment, the behavior of executing a cell selection process comprises: assessing whether there exists a cell satisfying the cell selection criterion.

In one subembodiment of the above embodiment, the meaning of the cell selection refers to reference 3GPP TS 38.304.

In one embodiment, as a response to the behavior of determining an occurrence of the radio connection problem on a second cell, execute cell selection process.

In one embodiment, as a response to the behavior of determining an occurrence of the radio connection problem on a second cell, initiate an RRC connection re-establishment procedure; as a response to the behavior of initiating the RRC connection reestablishment process, execute a Conditional Reconfiguration Evaluation process.

In one subembodiment of the embodiment, the behavior of executing a CHO assessment process comprises: assessing the first cell according to the second criterion.

In one subembodiment of the embodiment, the behavior of executing a CHO assessment process comprises: for each candidate cell in the first candidate cell group, judging whether its corresponding candidate condition is satisfied.

In one subembodiment of the embodiment, the meaning of the conditional reconfiguration evaluation is referred to section 5.3.5.13.4 of reference 3GPP TS 38.331.

In one embodiment, as a response to the behavior of determining an occurrence of the radio connection problem on a second cell, execute a conditional reconfiguration evaluation process.

In one embodiment, the behavior of assessing the first cell according to the second criterion comprises: judging whether the first cell meets the second criterion.

### Embodiment 10

Embodiment 10 illustrates a schematic diagram of a relation between a number of times that radio connection problem occurs at a first node and a first value according to one embodiment of the present application. The horizontal axis represents time, with T10.1, T10.2, T10.3, T10.4, and T10.5 being five increasing moments in time; at time T10.1, the radio connection failure occurs at the first node, and a number of times that the radio connection failure occurs at the first node is equal to 1; at time T10.2, the radio connection failure occurs at the first node, and a number of times that the radio connection failure occurs at the first node is equal to i; at time T10.3, the radio connection failure occurs at the first node, and a number of times that the radio connection failure occurs at the first node is equal to the first value; at time T10.4, the radio connection failure occurs at the first node, and a number of times that the radio connection failure occurs at the first node is equal to a sum of the first value and j; at time T10.5, the radio connection failure occurs at the first node, and a number of times that the radio connection failure occurs at the first node is equal to the second value; i is a non-negative integer, and i is not greater than the first value; j is a non-negative integer, and j is not greater than a difference value between the second value and the first value.

In embodiment 10, the first node receives a second signaling, and the second signaling is used to determine a first value; a relation between a number of times that the radio connection problem occurs at the first node and the first value is used to determine the target criterion; herein, the first value is a non-negative integer.

In one embodiment, the radio connection failure firstly occurs at the time T10.1 at the first node.

In one embodiment, the radio connection failure occurs at the first node at the T10.1 moment comprises RLF or HOF or CHOF.

In one embodiment, the radio connection failure occurs at the first node at a time after T10.1 comprises executing a reconfiguration with sync.

In one embodiment, the radio connection failure occurs at the first node at a time after T10.1 comprises cell re selection failure.

In one embodiment, the radio connection failure occurs at the first node at a time after T10.1 comprises configuration failure during applying reconfigurationWithSync.

In one embodiment, the radio connection failure occurs at the first node at a time after T10.1 comprises an expiration of T304 of MCG.

In one embodiment, the radio connection failure occurs at the first node at a time after T10.1 comprises an expiration of T311 of MCG.

In one embodiment, the radio connection failure occurs at the first node at a time after T10.1 comprises an expiration of the second timer of MCG.

In one embodiment, the radio connection failure occurs at the first node at a time after T10.1 comprises an expiration of the third timer of an MCG.

In one embodiment, the first node does not successfully establish an RRC connection from time T10.1 to time T10.5.

In one embodiment, the first node does not successfully establish an RRC connection from time T10.1 to time T10.5.

In one embodiment, any two radio connection failure occurred at the time T10.1 to the time T10.5 to the first node is for a same cell.

In one embodiment, there exists at least two radio connection failure occurring at the time T10.1 to the time T10.5 to the first node is for different cells.

In one embodiment, the time T10.1, the time T10.2, the time T10.3, the time T10.4, and the time T10.5 are only for explaining a sequence of radio connection failure and do not represent specific time.

In one embodiment, a time interval between any two continuous radio connection failure is the same.

In one embodiment, a time interval between any two continuous radio connection failure is different.

### Embodiment 11

Embodiment 11 illustrates a schematic diagram of a relation between a time interval that a radio connection problem occurs at a first node and a first time length according to one embodiment of the present application, The horizontal axis represents time, and T11.1, T11.2, and T11.3 are three moments ascending in time; at the T11.1 time, it is determined that the radio connection failure occurs; a time interval between T11.1 and T11.2 is the first time length; a time interval between the T11.1 time and the T11.3 time is a second time length.

In embodiment 11, the first node receives a first signaling, and the first signaling is used to determine a first time length; a relation between a time interval for an occurrence of the radio connection problem at the first node and the first time length is used to determine the target criterion; herein, the first time length comprises at least one ms.

In one embodiment, at the T11.1 time, it is determined that the radio connection failure occurs; as a response to the behavior of determining that the radio connection failure occurs, initiate an RRC connection re-establishment procedure; as a response to the behavior of initiating an RRC connection re-establishment procedure, execute a cell selection process; before the T11.2 time, the target criterion is the first criterion; at the T11.2 time and before the T11.3 time, the target criterion is the second criterion.

In one subembodiment of the embodiment, accompanying the behavior of initiating an RRC connection re-establishment procedure, start a third timer; a time interval between T11.1 and T11.3 comprises an expiration value of the second timer.

In one subsidiary embodiment of the subembodiment, the second timer comprises timer T311.

In one subsidiary embodiment of the subembodiment, at the time T11.3, the second timer reaches the expiration value of the second timer.

In one subsidiary embodiment of the above subembodiment, a start time of the second timer is later than the time T11.1.

In one subsidiary embodiment of the subembodiment, accompanying the behavior of initiating an RRC connection re-establishment procedure, start a third timer; a time interval between the time T11.1 and the time T11.2 comprises an expiration value of the third timer.

In one subordinate embodiment of the subsidiary subembodiment, at the time T11.2, the third timer reaches the expiration value of the third timer.

In one subsidiary embodiment of the subembodiment, a time interval between the time T11.1 and the time T11.2 comprises a value of the second timer, and at the time T11.2, the second timer reaches the value of the second timer.

In one embodiment, the first time length is related to timer T311.

In one embodiment, the first time length is not less than an expiration value of timer T311.

In one embodiment, the first time length is not less than a product of K1 and timer T311.

In one embodiment, the first time length is not greater than the second time length.

In one embodiment, the first time length is equal to the second time length.

In one embodiment, the first time length is less than the second time length.

In one embodiment, the second time length is equal to an expiration value of timer T311.

In one embodiment, the second time length is equal to a product of N1 and an expiration value of timer T311; N1 is configurable, N1 is a positive integer, and N1 is not greater than 16.

In one subembodiment of the above embodiment, N1 is equal to 1.

In one subembodiment of the above embodiment, N1 is equal to 2.

In one embodiment, when a time interval that the radio connection problem occurs at the first node reaches the second time length, enter into RRC_IDLE state.

In one embodiment, when a time interval that the radio connection problem occurs at the first node reaches the second time length, determine that no suitable cell is found.

In one embodiment, an expiration value of a second timer refers to a maximum running time of the second timer.

In one embodiment, an expiration value of a second timer refers to when a value of the second timer is equal to the expiration value of the second timer, the second timer expires.

In one embodiment, when the second timer is less than the value of the second timer, a cell selection process is executed according to the first criterion; when the second timer is not less than the value of the second timer and the second timer is less than the expiration value of the second timer, a cell selection process is executed according to the second criterion; both the first criterion and the second criterion are cell selection criteria.

In one embodiment, when the third timer is running, a cell selection process is executed according to the first criterion; when the third timer is not running and the second timer is running, a cell selection process is executed according to the second criterion; both the first criterion and the second criterion are cell selection criteria.

### Embodiment 12

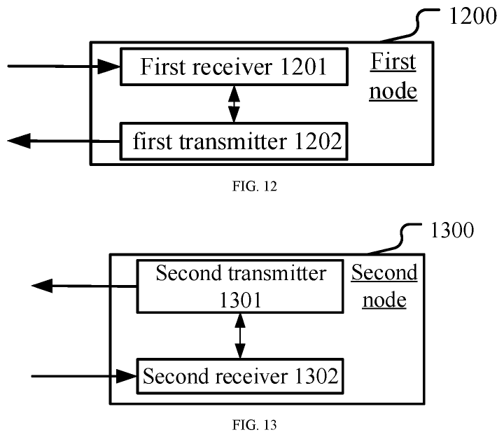

Embodiment 12 illustrates a structure block diagram of a processor in a first node according to one embodiment of the present application, as shown in FIG. 12. In FIG. 12, a processor 1200 in a first node comprises a first receiver 1201 and a first transmitter 1202.

The first receiver 1201 receives a first message, the first message is used to determine a first criterion and a second criterion; determines that a first cell meets a target criterion, the target criterion is one of the first criterion or the second criterion;
the first transmitter 1202 transmits a first signal on the first cell;

In embodiment 12, the first criterion comprises at least one of time information or location information, and the first criterion comprises a measurement result for reference signal(s) of the first cell; the second criterion comprises a measurement result for reference signal(s) of the first cell, and the second criterion does not comprise time information and location information; the first signal is used to establish a connection with the first cell; whether the target criterion is the first criterion or the second criterion is related to whether a radio connection problem occurs at the first node.

In one embodiment, the first transmitter 1202 transmits a second message, and the second message indicates the target criterion.

In one embodiment, the first receiver 1201 receives a first signaling, and the first signaling is used to determine a first time length; a relation between a time interval for an occurrence of the radio connection problem at the first node and the first time length is used to determine the target criterion; herein, the first time length comprises at least one ms.

In one embodiment, the first receiver 1201 receives a second signaling, and the second signaling is used to determine a first value; a relation between a number of times that the radio connection problem occurs at the first node and the first value is used to determine the target criterion; herein, the first value is a non-negative integer.

In one embodiment, the first receiver 1201 determines that the radio connection problem occurs on a second cell; the behavior of determining that the radio connection problem occurs on a second cell is used to determine that a priority of the first cell is higher than a priority of the second cell; herein, the priority of the first cell being higher than the priority of the second cell is used to determine that the second criterion does not comprise time information and location information; the first cell is different from the second cell.

In one embodiment, the first receiver 1201 receives a third signaling, the third signaling indicates a first candidate cell group, the first candidate cell group comprises at least one candidate cell, each candidate cell in the first candidate cell group is associated with a candidate condition and a candidate configuration; herein, the first cell is a candidate cell in the first candidate cell group.

In one embodiment, the first receiver 1201 receives a first offset; herein, the target criterion is related to a candidate condition corresponding to the first cell and the first offset.

In one embodiment, the first receiver 1201 comprises the antenna 452, the receiver 454, the multi-antenna receiving processor 458, the receiving processor 456, the controller/processor 459, the memory 460 and the data source 467 in FIG. 4 of the present application.

In one embodiment, the first receiver 1201 comprises the antenna 452, the receiver 454, the multi-antenna receiving processor 458 and the receiving processor 456 in FIG. 4 of the present application.

In one embodiment, the first receiver 1201 comprises the antenna 452, the receiver 454 and the receiving processor 456 in FIG. 4 of the present application.

In one embodiment, the first transmitter 1202 comprises the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1202 comprises the antenna 452, the transmitter 454, the multi-antenna transmitting processor 457 and the transmitting processor 468 in FIG. 4 of the present application.

In one embodiment, the first transmitter 1202 comprises the antenna 452, the transmitter 454 and the transmitting processor 468 in FIG. 4 of the present application.

### Embodiment 13

Embodiment 13 illustrates a structure block diagram of a processor in a second node according to one embodiment of the present application, as shown in FIG. 13. In FIG. 13, a processor 1300 of a second node comprises a second transmitter 1301 and a second receiver 1302.

The second transmitter 1301 transmits a first message, the first message is used to determine a first criterion and a second criterion;
the second receiver 1302 receives a first signal on a first cell;

In embodiment 13, a first cell meeting a target criterion is determined, the target criterion is one of the first criterion or the second criterion; the first criterion comprises at least one of time information or location information, and the first criterion comprises a measurement result for reference signal(s) of the first cell; the second criterion comprises a measurement result for reference signal(s) of the first cell, and the second criterion does not comprise time information and location information; the first signal is used to establish a connection with the first cell; whether the target criterion is the first criterion or the second criterion is related to whether a radio connection problem occurs in a receiver of the first message.

In one embodiment, the first cell meeting a target criterion is determined by a receiver of the first message.

In one embodiment, second message is transmitted, the second message indicates the target criterion.

In one embodiment, the second message is transmitted by a receiver of the first message.

In one embodiment, the second receiver 1302 receives the second message, and the second message indicates the target criterion.

In one embodiment, the second message is received by a maintenance base station of the first cell.

In one embodiment, the second message is received by a maintenance base station for a current serving cell of the first node.

In one embodiment, the second transmitter 1301 transmits a first signaling, and the first signaling is used to determine a first time length; a relation between a time interval for an occurrence of the radio connection problem at a receiver of the first message and the first time length is used to determine the target criterion; herein, the first time length comprises at least one ms.

In one embodiment, the second transmitter 1301 transmits a second signaling, and the second signaling is used to determine a first value; a relation between a number of times that the radio connection problem occurs in a receiver of the first message and the first value is used to determine the target criterion; herein, the first value is a non-negative integer.

In one embodiment, an occurrence of the radio connection problem on a second cell is determined; an occurrence of the radio connection problem on a second cell is used to determine that a priority of the first cell is higher than a priority of the second cell; the priority of the first cell being higher than the priority of the second cell is used to determine that the second criterion does not comprise time information and location information; the first cell is different from the second cell.

In one embodiment, an occurrence of the radio connection problem on a second cell is determined by a receiver of the first message.

In one embodiment, the second transmitter 1301 transmits a third signaling, the third signaling indicates a first candidate cell group, the first candidate cell group comprises at least one candidate cell, each candidate cell in the first candidate cell group is associated with a candidate condition and a candidate configuration; herein, the first cell is a candidate cell in the first candidate cell group.

In one embodiment, the second transmitter 1301 transmits a first offset; herein, the target criterion is related to a candidate condition corresponding to the first cell and the first offset.

In one embodiment, the second transmitter 1301 comprises the antenna 420, the transmitter 418, the multi-antenna transmitting processor 471, the transmitting processor 416, the controller/processor 475 and the memory 476 in FIG. 4 of the present application.

In one embodiment, the second transmitter 1301 comprises the antenna 420, the transmitter 418, the multi-antenna transmitting processor 471 and the transmitting processor 416 in FIG. 4 of the present application.

In one embodiment, the second transmitter 1301 comprises the antenna 420, the transmitter 418 and the transmitting processor 416 in FIG. 4 of the present application.

In one embodiment, the second receiver 1302 comprises the antenna 420, the receiver 418, the multi-antenna receiving processor 472, the receiving processor 470, the controller/processor 475 and the memory 476 in FIG. 4 of the present application.

In one embodiment, the second receiver 1302 comprises the antenna 420, the receiver 418, the multi-antenna receiving processor 472 and the receiving processor 470 in FIG. 4 of the present application.

In one embodiment, the second receiver 1302 comprises the antenna 420, the receiver 418 and the receiving processor 470 in FIG. 4 of the present application.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, tele-controlled aircrafts, aircrafts, diminutive airplanes, mobile phones, tablet computers, notebooks, vehicle-mounted communication equipment, wireless sensors, network cards, Internet of Things (IoT) terminals, RFID terminals, NB-IOT terminals, Machine Type Communication (MTC) terminals, enhanced MTC (eMTC) terminals, data card, network cards, vehicle-mounted communication equipment, low-cost mobile phones, low-cost tablets and other wireless communication devices. The UE and terminal in the present application include but not limited to unmanned aerial vehicles, communication modules on unmanned aerial vehicles, tele-controlled aircrafts, aircrafts, diminutive airplanes, mobile phones, tablet computers, notebooks, vehicle-mounted communication equipment, wireless sensor, network cards, terminals for Internet of Things, RFID terminals, NB-IOT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving a first message, the first message being used to determine a first criterion and a second criterion; determining that a first cell meets a target criterion, the target criterion being one of the first criterion or the second criterion; as a response to determining that a first cell meets a target criterion, applying a candidate configuration corresponding to the first cell; and
a first transmitter, as a response to a completion of applying a candidate configuration corresponding to the first cell, transmitting a first signal on the first cell, the first signal being used to establish a connection with the first cell, the first signal comprising an RRCReconfigurementComplete message or an RRCConnectionReconfigurementComplete message;
wherein the first criterion comprises location information, and the first criterion comprises a measurement result for reference signal(s) of the first cell; the second criterion comprises a measurement result for reference signal(s) of the first cell, and the second criterion does not comprise time information and location information; whether the target criterion is the first criterion or the second criterion is related to whether a radio connection problem occurs at the first node.

2. The first node according to claim 1, wherein the location information comprises a distance between the first node and a reference point, and the reference point is configured through network.

3. The first node according to claim 1, wherein the time information comprises at least one time, and/or, the time information comprises Universal Time Coordinated (UTC), and/or, the time information is related to a satellite ephemeris.

4. The first node according to claim 1, wherein a candidate configuration corresponding to the first cell comprises a configuration in a ReconfigurationWithSync field or a mobilityControlInfo field.

5. The first node according to claim 1, wherein the first message comprises a field, a name of the field comprises attemptCondReconfig or attemptCondReconf, and a value of the field is set as true.

6. The first node according to claim 1, comprising:
the third receiver, receiving a third signaling, the third signaling indicating a first candidate cell group, the first candidate cell group comprising at least one candidate cell, each candidate cell in the first candidate cell group being associated with a candidate condition and a candidate configuration;
wherein the first cell is a candidate cell in the first candidate cell group; the candidate configuration corresponding to the first cell is configured by the third signaling.

7. The first node according to claim 1, wherein the third signaling comprises ConditionalReconfigurement, and the ConditionalReconfigurement comprises CondReconfigToAddModList or CondReconfigurementToAddModList.

8. The first node according to claim 1, wherein the first message comprises at least one RRC message; an RRC message in the first message is used to determine the first criterion, and another RRC message in the first message is used to determine the second criterion.

9. The first node according to claim 1, wherein the first message comprises SIB1, and the first message comprise an RRCReconfiguration message or an RRCConnectionReconfiguration message.

10. The first node according to claim 1, wherein the radio connection problem comprises any of Reconfiguration with sync Failure or Radio Link Failure (RLF).

11. The first node according to claim 1, wherein if the radio connection problem does not occur on a second cell, the first node assesses the first cell according to the first criterion; if the radio connection problem occurs on a second cell, the first node assesses the first cell according to the second criterion; the second cell is a PCell.

12. The first node according to claim 1, wherein as a response to the behavior of determining that the radio connection problem occurs on a second cell, initiate an RRC connection re-establishment procedure; as a response to the behavior of initiating an RRC connection re-establishment procedure, execute a cell selection process; the behavior of executing a cell selection process comprises: assessing the first cell according to the second criterion.

13. The first node according to claim 1, wherein the first criterion comprises a CHO execution condition, and the second criterion comprises a cell selection criterion.

14. The first node according to claim 1, wherein the first criterion comprises an entry condition for an A3 event, or the first criterion comprises an entry condition for an A4 event, or the first criterion comprises an entry condition for an A5 event.

15. The first node according to claim 1, wherein the first criterion comprises a first distance<a target distance threshold, and a second distance>a given distance threshold; the target distance threshold is configurable; the given distance threshold is configurable.

16. A second node for wireless communications, comprising:
a second transmitter, transmitter a first message, the first message being used to determine a first criterion and a second criterion; and
a second receiver, receiving a first signal on a first cell, the first signal being used to establish a connection with the first cell, the first signal comprising an RRCReconfigurationComplete message or an RRCConnectionReconfigurationComplete message;
wherein the first cell meeting a target criterion is determined, the target criterion is one of the first criterion or the second criterion; as a response to the first cell meeting a target criterion being determined by a receiver of the first message, a receiver of the first message applies a candidate configuration corresponding to the first cell; as a response to a completion of applying a candidate configuration corresponding to the first cell by a receiver of the first message, a receiver of the first message transmits the first signal; the first criterion comprises location information, and the first criterion comprises a measurement result for reference signal(s) of the first cell; the second criterion comprises a measurement result for reference signal(s) of the first cell, and the second criterion does not comprise time information and location information; whether the target criterion is the first criterion or the second criterion is related to whether a radio connection problem occurs at a receiver of the first message.

17. The second node according to claim 16, wherein the location information comprises a distance between the first node and a reference point, and the reference point is configured through network; wherein the time information comprises at least one time, and/or, the time information comprises Universal Time Coordinated (UTC), and/or, the time information is related to a satellite ephemeris.

18. The second node according to claim 16, wherein a candidate configuration corresponding to the first cell comprises a configuration in a ReconfigurationWithSync field or a mobilityControlInfo field; the first message comprises a field, and a name of the field comprises attemptCondReconfig or attemptCondReconf, and a value of the field is set as true.

19. The second node according to claim 16, wherein the first message comprises SIB1, and the first message comprise an RRCReconfiguration message or an RRCConnectionReconfiguration message.

20. A method in a first node for wireless communications, comprising:
receiving a first message, the first message being used to determine a first criterion and a second criterion; determining that a first cell meets a target criterion, the target criterion being one of the first criterion or the second criterion; as a response to determining that a first cell meets a target criterion, applying a candidate configuration corresponding to the first cell; and
as a response to a completion of applying a candidate configuration corresponding to the first cell, transmitting a first signal on the first cell, the first signal being used to establish a connection with the first cell, the first signal comprising an RRCReconfigurementComplete message or an RRCConnectionReconfigurementComplete message;
wherein the first criterion comprises location information, and the first criterion comprises a measurement result for reference signal(s) of the first cell; the second criterion comprises a measurement result for reference signal(s) of the first cell, and the second criterion does not comprise time information and location information; whether the target criterion is the first criterion or the second criterion is related to whether a radio connection problem occurs at the first node.
